(19) United States
(12) Patent Application Publication
(10) Pub. No.: US 2021/0067802 A1
(43) Pub. Date: Mar. 4, 2021

(54) VIDEO DECODING METHOD AND DEVICE USING CROSS-COMPONENT PREDICTION, AND VIDEO ENCODING METHOD AND DEVICE USING CROSS-COMPONENT PREDICTION

(71) Applicant: SAMSUNG ELECTRONICS CO., LTD., Suwon-si (KR)

(72) Inventors: Bo-ra JIN, Yongin-si (KR); Na-rae CHOI, Seoul (KR)

(73) Assignee: SAMSUNG ELECTRONICS CO., LTD., Suwon-si (KR)

(21) Appl. No.: 16/644,414

(22) PCT Filed: Sep. 20, 2018
(86) PCT No.: PCT/KR2018/011142

§ 371 Date: Mar. 4, 2020

Related U.S. Application Data
(60) Provisional application No. 62/563,307, filed on Sep. 26, 2017.

(51) Int. Cl. H04N 19/593; H04N 19/11; H04N 19/117; H04N 19/132; H04N 19/176; H04N 19/186

(52) U.S. Cl. CPC H04N 19/593; H04N 19/11; H04N 19/186; H04N 19/132; H04N 19/176; H04N 19/117

(57) ABSTRACT

Provided are a method and device for generating a prediction block of a chroma component from a luma component reconstructed through modeling using a correlation between the luma component and the chroma component during video encoding and decoding processes. A video decoding method proposed in the disclosure includes: deriving weight information and deviation information about a chroma sample of a reconstructed adjacent chroma block neighboring a current chroma block and a reconstructed luma sample of an adjacent luma block corresponding to the adjacent chroma block in order to reconstruct chroma samples of the current chroma block; reconstructing luma samples of a current luma block corresponding to the current chroma block according to a prediction mode of the current luma block; and reconstructing the chroma samples of the current chroma block by using the reconstructed luma samples of the current luma block, the weight information, and the deviation information.

### TECHNICAL FIELD

The disclosure relates to a video decoding method and a video decoding device, and more particularly, to a method and device for generating a prediction block of a chroma component from a reconstructed luma component through modeling using a correlation between the luma component and the chroma component.

### BACKGROUND ART

Image data is encoded by a codec according to a predetermined data compression standard, for example, a moving picture expert group (MPEG) standard, and is then stored in the form of bitstreams in a recording medium or transmitted through a communication channel.

With development and propagation of hardware capable of reproducing and storing high-resolution or high-definition image content, a need for a codec for effectively encoding or decoding high-resolution or high-definition image content is increasing. Encoded image content is reproduced by being decoded. Recently, methods for effectively compressing such high-resolution or high-definition image content are being performed. For example, methods for effectively implementing image compression technology through a process of splitting images to be encoded by an arbitrary method or rendering data are proposed.

As one of techniques for rendering data, a method of using 35 modes of intra-prediction to generate an intra-prediction block of a luma component in intra-prediction, and using a prediction mode using an intra-prediction mode of a luma component as it is, a horizontal prediction mode, a vertical prediction mode, a DC mode, and a planar mode (5 modes in comparison to basic 35 modes) to generate an intra-prediction block of a chroma component is generally used.

### DESCRIPTION OF EMBODIMENTS

### Technical Problem

A method and device for modeling, when predicting a chroma component during video encoding and decoding processes, a correlation between an adjacent luma component and an adjacent chroma component, which are already reconstructed, and predicting a block of a current chroma component by using a reconstructed area of a current luma component are proposed.

### Solution to Problem

A video decoding method proposed in the disclosure to overcome the above technical problem includes: deriving weight information and deviation information about a chroma sample of a reconstructed adjacent chroma block neighboring a current chroma block and a reconstructed luma sample of an adjacent luma block corresponding to the adjacent chroma block in order to reconstruct chroma samples of the current chroma block; reconstructing luma samples of a current luma block corresponding to the current chroma block according to a prediction mode of the current luma block; and reconstructing the chroma samples of the current chroma block by using the reconstructed luma samples of the current luma block, the weight information, and the deviation information.

A video decoding device proposed in the disclosure to overcome the above technical problem includes: a memory; and at least one processor connected to the memory, wherein the at least one processor is configured to: derive weight information and deviation information about a chroma sample of a reconstructed adjacent chroma block neighboring a current chroma block and a reconstructed luma sample of an adjacent luma block corresponding to the adjacent chroma block in order to reconstruct chroma samples of the current chroma block; reconstruct luma samples of a current luma block corresponding to the current chroma block according to a prediction mode of the current luma block; and reconstruct the chroma samples of the current chroma block by using the reconstructed luma samples of the current luma block, the weight information, and the deviation information.

A video encoding method proposed in the disclosure to overcome the above technical problem includes: deriving weight information and deviation information about a chroma sample of an adjacent chroma block neighboring a current chroma block and an encoded luma sample of an adjacent luma block corresponding to the adjacent chroma block in order to predict chroma samples of the current chroma block; predicting luma samples of a current luma block corresponding to the current chroma block to be predicted according to a prediction mode of the current luma block; determining the chroma samples of the current chroma block by using the predicted luma samples of the current luma block, the weight information, and the deviation information; and encoding residual values between the determined chroma samples of the current chroma block and an original chroma sample of the current chroma block.

A video encoding device proposed in the disclosure to overcome the above technical problem includes: a memory; and at least one processor connected to the memory, wherein the at least one processor is configured to: derive weight information and deviation information about a chroma sample of an adjacent chroma block neighboring a current chroma block and an encoded luma sample of an adjacent luma block corresponding to the adjacent chroma block in order to predict chroma samples of the current chroma block; predict luma samples of a current luma block corresponding to the current chroma block to be predicted according to a prediction mode of the current luma block; determine the chroma samples of the current chroma block by using the predicted luma samples of the current luma block, the weight information, and the deviation information; and encode residual values between the determined chroma samples of the current chroma block and an original chroma sample of the current chroma block.

### Advantageous Effects of Disclosure

By modeling and using a correlation between a reconstructed luma component and a reconstructed chroma component in order to generate a prediction block of a chroma component during video encoding and decoding processes, prediction accuracy of the chroma component may increase without increasing complexity, thereby improving efficiency and performance of chroma prediction while raising reliability.

### BRIEF DESCRIPTION OF DRAWINGS

FIG. 1 shows a schematic block diagram of an image decoding device according to an embodiment.

FIG. 2 shows a flowchart of an image decoding method according to an embodiment.

FIG. 3 shows a process in which an image decoding device splits a current coding unit to determine at least one coding unit, according to an embodiment.

FIG. 4 shows a process in which an image decoding device splits a coding unit having a non-square shape to determine at least one coding unit, according to an embodiment.

FIG. 5 shows a process in which an image decoding device splits a coding unit based on at least one of block shape information and split shape mode information, according to an embodiment.

FIG. 6 shows a method in which an image decoding device determines a predetermined coding unit from among an odd number of coding units, according to an embodiment.

FIG. 7 shows an order of processing a plurality of coding units when an image decoding device determines the plurality of coding units by splitting a current coding unit, according to an embodiment.

FIG. 8 shows a process in which, when coding units are not processable in a predetermined order, an image decoding device determines that the current coding unit is to be split into an odd number of coding units, according to an embodiment.

FIG. 9 shows a process in which an image decoding device splits a first coding unit to determine at least one coding unit, according to an embodiment.

FIG. 10 shows a case in which an image decoding device limits split shapes of a second coding unit having a non-square shape determined when a first coding unit is split, when the second coding unit satisfies a predetermined condition, according to an embodiment.

FIG. 11 shows a process in which an image decoding device splits a square shaped coding unit when split shape mode information does not represent a split into four square shaped coding units, according to an embodiment.

FIG. 12 illustrates that a processing order between a plurality of coding units may be changed depending on a process of splitting a coding unit, according to an embodiment.

FIG. 13 illustrates a process of determining a depth of a coding unit when a shape and size of the coding unit change, when the coding unit is recursively split such that a plurality of coding units are determined, according to an embodiment.

FIG. 14 illustrates depths that are determinable based on shapes and sizes of coding units, and part indexes (PIDs) that are for distinguishing the coding units, according to an embodiment.

FIG. 15 illustrates that a plurality of coding units are determined based on a plurality of predetermined data units included in a picture, according to an embodiment.

FIG. 16 illustrates a processing block serving as a criterion for determining a determination order of reference coding units included in a picture, according to an embodiment.

FIG. 17 shows a block diagram of a video decoding device according to an embodiment.

FIG. 18 shows a flowchart of a video decoding method according to an embodiment.

FIG. 19 shows a block diagram of a video encoding device according to an embodiment.

FIG. 20 shows a flowchart of a video encoding method according to an embodiment.

FIG. 21 shows an example of generating a predictor for a chroma sample Ĉ by using 6 luma samples L₁ to L₆.

FIG. 22 shows a reconstructed luma sample, a chroma sample, and an intra-prediction mode direction.

FIGS. 23A and 23B show modeling parameters respectively of a plurality of adjacent blocks neighboring a current block.

FIG. 24 shows luma samples of a reconstructed luma block and a chroma sample of a reconstructed chroma block.

FIG. 25 shows luma samples of a current luma block and a chroma sample of a current chroma block.

FIGS. 26A, 26B, 26C, and 26D show an example in which a cross-component prediction method is applied when luma samples of a luma block are split according to a predetermined criterion.

FIGS. 27A and 27B show modeling parameters respectively of a plurality of adjacent blocks including blocks split into segments neighboring a current block.

FIG. 28 is a block diagram showing a process of using adjacent blocks located in right, upper, and right-upper sides of a current block.

FIG. 29 shows modeling parameters of adjacent blocks located in left, left-upper, upper, right-upper, and right sides of a current block.

### BEST MODE

A video decoding method according to an embodiment proposed in the disclosure includes: deriving weight information and deviation information about a chroma sample of a reconstructed adjacent chroma block neighboring a current chroma block and a reconstructed luma sample of an adjacent luma block corresponding to the adjacent chroma block in order to reconstruct chroma samples of the current chroma block; reconstructing luma samples of a current luma block corresponding to the current chroma block according to a prediction mode of the current luma block; and reconstructing the chroma samples of the current chroma block by using the reconstructed luma samples of the current luma block, the weight information, and the deviation information.

According to an embodiment, the chroma samples of the current chroma block may be respectively values determined by multiplying N predetermined luma samples among the reconstructed luma samples of the current luma block, respectively, by N predetermined weights in the weight information, the N predetermined weights respectively corresponding to the N predetermined luma samples, to obtain weighted sums and adding a deviation value in the weight information to the weighted sums.

According to an embodiment, the N predetermined luma samples may be a luma sample of the current luma block corresponding to a position of a chroma sample of the current chroma block and samples neighboring the luma sample of the corresponding current luma block.

According to an embodiment, the N predetermined luma samples may be a luma sample of the current luma block corresponding to a position of a chroma sample of the current chroma block and arbitrary samples not neighboring the luma sample of the corresponding current luma block.

According to an embodiment, a prediction mode of the adjacent luma block may be an intra-prediction mode, the weight information may be a modeling parameter value representing a correlation between the luma samples and the chroma samples, the chroma samples of the current chroma block may be reconstructed by using N predetermined luma samples among the reconstructed luma samples of the current luma block, N predetermined weights respectively corresponding to the N predetermined luma samples, and a deviation value of the deviation information, and the N predetermined weights may be a value resulting from multiplying a fixed weight determined in advance according to the intra-prediction mode by the modeling parameter value representing the correlation between the luma samples and the chroma samples.

According to an embodiment, the fixed weight may be determined according to a direction of the intra-prediction mode.

According to an embodiment, the fixed weight may be a fraction value using a N-tap filter according to the intra-prediction mode.

According to an embodiment, when a prediction mode of the current chroma bock is a direct mode (DM), the chroma samples of the current chroma block may be respectively averages of a chroma predictor generated in the DM, and values determined by multiplying N predetermined luma samples in the reconstructed luma samples of the current luma block by N predetermined weights respectively corresponding to the N predetermined luma samples among the weight information to obtain weighted sums and adding a deviation value in the deviation information to the weighted sums.

According to an embodiment, the adjacent chroma block may be located in at least one of a left side, a upper side, and a left-upper side of the current chroma block.

According to an embodiment, the adjacent chroma block may be reconstructed earlier than the current chroma block, and located in at least one of a right side, a upper side, and a right-upper side of the current chroma block.

According to an embodiment, the adjacent chroma block may include a plurality of blocks, the weight information and the deviation information may represent correlations between the plurality of blocks and the adjacent luma block corresponding to the plurality of blocks, and the chroma samples of the current chroma block may be reconstructed according to the weight information and the deviation information of the plurality of blocks.

According to an embodiment, the video decoding method may further include: segmenting the current luma block into at least two first segment areas based on a predetermined criterion; configuring a segment map for the at least two first segment areas; down-sampling the current luma block according to the segment map to segment the current chroma block into at least two second segment areas to correspond to the at least two first segment areas of the current luma block; and reconstructing a chroma sample corresponding to the second segment areas of the current chroma block by using the weight information, the deviation information, and a luma sample of the current luma block belonging to the first segment areas corresponding to the second segment areas of the current chroma block.

A video encoding method according to an embodiment proposed in the disclosure includes: deriving weight information and deviation information about a chroma sample of an encoded adjacent chroma block neighboring a current chroma block and an encoded luma sample of an adjacent luma block corresponding to the adjacent chroma block in order to reconstruct chroma samples of the current chroma block; reconstructing luma samples of a current luma block corresponding to the current chroma block according to a prediction mode of the current luma block; determining the chroma samples of the current chroma block by using the predicted luma samples of the current luma block, the weight information, and the deviation information; and encoding residual values between the determined chroma samples of the current chroma block and an original chroma sample of the current chroma block.

A video decoding device according to an embodiment proposed in the disclosure includes: a memory; and

at least one processor connected to the memory, wherein the at least one processor may be configured to: derive weight information and deviation information about a chroma sample of a reconstructed adjacent chroma block neighboring a current chroma block and a reconstructed luma sample of an adjacent luma block corresponding to the adjacent chroma block in order to reconstruct chroma samples of the current chroma block; reconstruct luma samples of a current luma block corresponding to the current chroma block according to a prediction mode of the current luma block; and reconstruct the chroma samples of the current chroma block by using the reconstructed luma samples of the current luma block, the weight information, and the deviation information.

A video encoding device according to an embodiment proposed in the disclosure includes: a memory; and at least one processor connected to the memory, wherein the at least one processor is configured to: derive weight information and deviation information about a chroma sample of an adjacent chroma block neighboring a current chroma block and an encoded luma sample of an adjacent luma block corresponding to the adjacent chroma block in order to predict chroma samples of the current chroma block; predict luma samples of a current luma block corresponding to the current chroma block according to a prediction mode of the current luma block; determine the chroma samples of the current chroma block by using the predicted luma samples of the current luma block, the weight information, and the deviation information; and encode residual values between the determined chroma samples of the current chroma block and an original chroma sample of the current chroma block.

### MODE OF DISCLOSURE

Advantages and features of disclosed embodiments and a method of achieving the advantages and features will be apparent by referring to embodiments described below in connection with the accompanying drawings. However, the present disclosure is not restricted by these embodiments but can be implemented in many different forms, and the present embodiments are provided to complete the present disclosure and to allow those having ordinary skill in the art to understand the scope of the disclosure.

Terms used in this specification will be briefly described, and the disclosed embodiments will be described in detail.

Although general terms being widely used in the present specification were selected as terminology used in the disclosure while considering the functions of the disclosure, they may vary according to intentions of one of ordinary skill in the art, judicial precedents, the advent of new technologies, and the like. Terms arbitrarily selected by the applicant of the disclosure may also be used in a specific case. In this case, their meanings will be described in detail in the detailed description of the disclosure. Hence, the terms must be defined based on the meanings of the terms and the contents of the entire specification, not by simply stating the terms themselves.

It is to be understood that the singular forms “a,” “an,” and “the” include plural referents unless the context clearly dictates otherwise.

It will be understood that when a certain part “includes” a certain component, the part does not exclude another component but can further include another component, unless the context clearly dictates otherwise.

As used herein, the terms “portion”, “module”, or “unit” refers to a software or hardware component that performs predetermined functions. However, the term “portion”, “module” or “unit” is not limited to software or hardware. The “portion”, “module”, or “unit” may be configured in an addressable storage medium, or may be configured to run on at least one processor. Therefore, as an example, the “portion”, “module”, or “unit” includes: components such as software components, object-oriented software components, class components, and task components; processes, functions, attributes, procedures, sub-routines, segments of program codes, drivers, firmware, microcodes, circuits, data, databases, data structures, tables, arrays, and variables. Functions provided in the components and “portions”, “modules” or “units” may be combined into a smaller number of components and “portions”, “modules” and “units”, or sub-divided into additional components and “portions”, “modules” or “units”.

In an embodiment of the present disclosure, the “portion”, “module”, or “unit” may be implemented as a processor and a memory. The term “processor” should be interpreted in a broad sense to include a general-purpose processor, a central processing unit (CPU), a microprocessor, a digital signal processor (DSP), a controller, a microcontroller, a state machine, etc. In some embodiments, the “processor” may indicate an application-specific integrated circuit (ASIC), a programmable logic device (PLD), a field programmable gate array (FPGA), etc. The term “processor” may indicate a combination of processing devices, such as, for example, a combination of a DSP and a microprocessor, a combination of a plurality of microprocessors, a combination of one or more microprocessors coupled to a DSP core, or a combination of arbitrary other similar components.

The term “memory” should be interpreted in a broad sense to include an arbitrary electronic component capable of storing electronic information. The term “memory” may indicate various types of processor-readable media, such as random access memory (RAM), read only memory (ROM), non-volatile RAM (NVRAM), programmable ROM (PROM), erasable programmable ROM (EPROM), electrically erasable PROM (EEPROM), flash memory, a magnetic or optical data storage device, registers, etc. When a processor can read information from a memory and/or write information in the memory, the memory can be considered to electronically communicate with the processor. A memory integrated into a process electronically communicates with the processor.

Hereinafter, an “image” may represent a static image such as a still image of video, or a moving image, that is, a dynamic image such as video itself.

Hereinafter, a “sample”, which is data assigned to a sampling position of an image, means data that is to be processed. For example, pixel values in an image of a spatial region and transform coefficients on a transform region may be samples. A unit including at least one of such samples may be defined as a block.

Hereinafter, embodiments will be described in detail with reference to the accompanying drawings so that the present disclosure may be readily implemented by one of ordinary skill in the technical field to which the present disclosure pertains. Also, in the drawings, parts irrelevant to the description will be omitted for the simplicity of explanation.

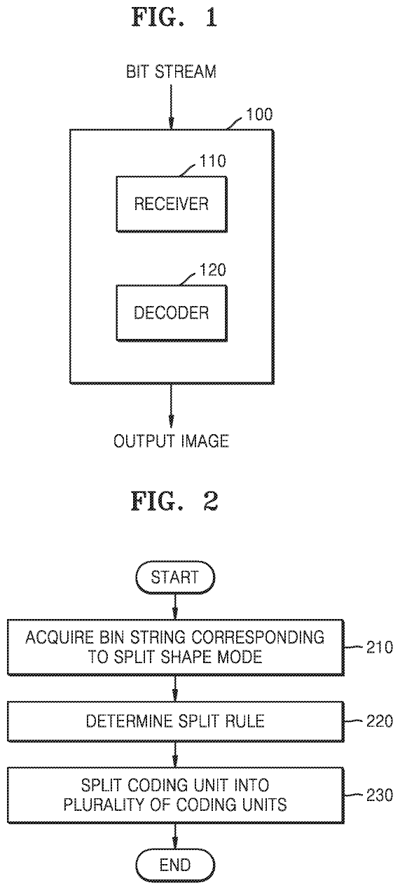

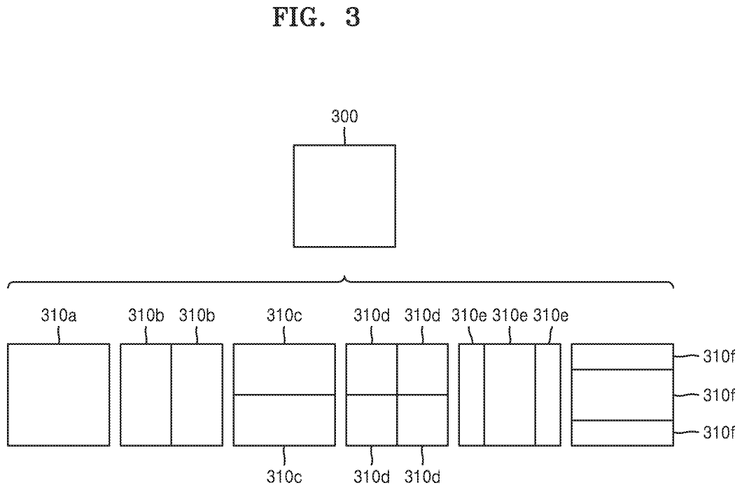

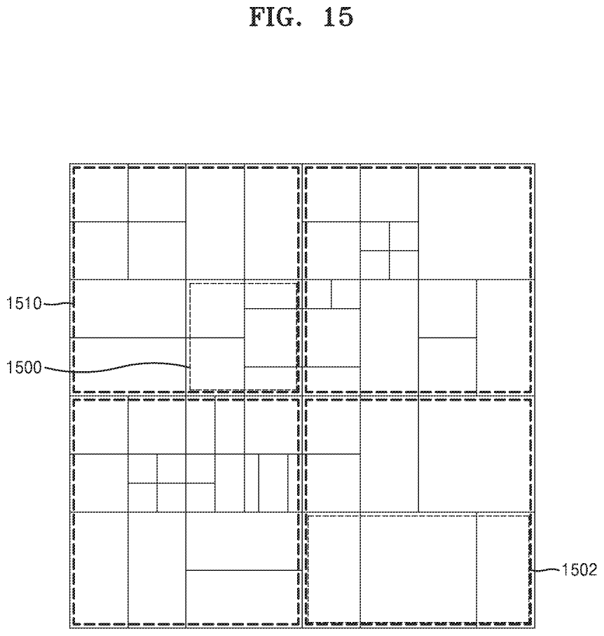

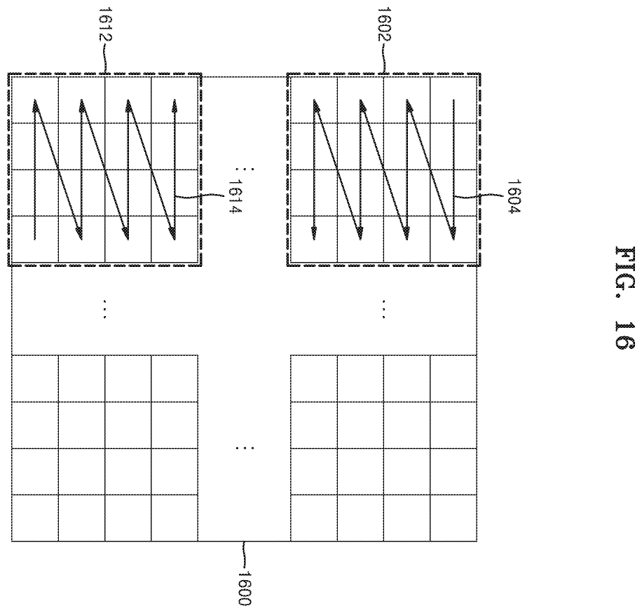

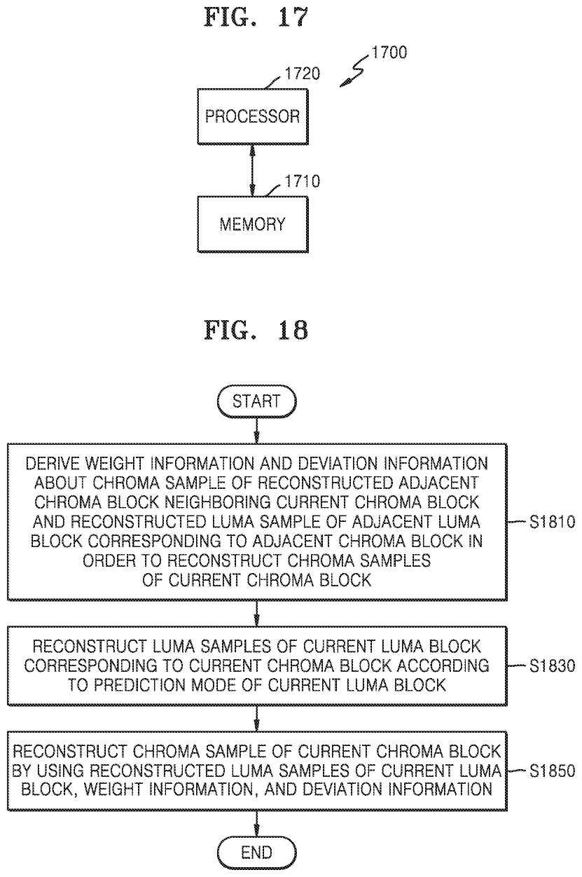

Hereinafter, an image encoding device, an image decoding device, an image encoding method, and an image decoding method, according to an embodiment, will be described with reference to FIGS. 1 to 16. A method of determining a data unit of an image, according to an embodiment, will be described with reference to FIGS. 3 to 16, and a method of modeling a correlation between a luma component of a reconstructed adjacent luma block neighboring a current luma block and a chroma component of a reconstructed adjacent chroma block neighboring a current chroma block to generate a prediction block of a chroma component of the current chroma block from a reconstructed luma component of the current luma block, according to an embodiment, will be described with reference to FIGS. 17 to 29.

Hereinafter, a method and device for selecting a context model adaptively based on various shapes of coding units, according to an embodiment of the disclosure, will be described with reference to FIGS. 1 and 2.

FIG. 1 shows a schematic block diagram of an image decoding device 100 according to an embodiment.

The image decoding device 100 may include a receiver 110 and a decoder 120. The receiver 110 and the decoder 120 may include at least one processor. Also, the receiver 110 and the decoder 120 may include a memory storing instructions that are to be executed by the at least one processor.

The receiver 110 may receive a bit stream. The bit stream may include information resulting from encoding an image in an image encoding device 2200 which will be described later. Also, the bit stream may be transmitted from the image encoding device 2200. The image decoding device 100 may be connected to the image encoding device 2200 in a wired or wireless manner, and the receiver 110 may receive a bit stream in a wired or wireless manner. The receiver 110 may receive a bit stream from a storage medium, such as an optical media, a hard disk, etc. The decoder 120 may reconstruct an image based on information acquired from the received bit stream. The decoder 120 may acquire a syntax element for reconstructing the image from the bit stream. The decoder 120 may reconstruct the image based on the syntax element.

Operations of the image decoding device 100 will be described in more detail with reference to FIG. 2.

FIG. 2 shows a flowchart of an image decoding method according to an embodiment.

According to an embodiment of the disclosure, the receiver 110 may receive a bit stream.

The image decoding device 100 may perform an operation 210 of acquiring a bin string corresponding to a split shape mode of a coding unit from the bit stream. The image decoding device 100 may perform an operation 220 of determining a split rule of the coding unit. Also, the image decoding device 100 may perform an operation 230 of splitting the coding unit into a plurality of coding units based on at least one of the bin string corresponding to the split shape mode and the split rule. The image decoding device 100 may determine a first allowable size range of the coding unit according to a ratio of width and height of the coding unit to determine the split rule. The image decoding device 100 may determine a second allowable size range of the coding unit according to a split shape mode of the coding unit to determine the split rule.

Hereinafter, splitting of a coding unit according to an embodiment of the disclosure will be described in detail.

First, a picture may be split into one or more slices. A slice may be a sequence of one or more coding tree units (CTUs). As a concept that is contrary to the CTU, there is a coding tree block (CTB).

The CTB means a N×N block including N×N samples, wherein N is an integer. Each color component may be split into one or more coding tree blocks.

When a picture has three sample arrays (sample arrays for Y, Cr, and Cb components), a CTU may be a unit including a coding tree block of a luma sample, two coding tree blocks of chroma samples corresponding to the luma sample, and syntax structures used to encode the luma sample and the chroma samples. When a picture is a monochrome picture, a CTU may be a unit including a coding tree block of monochrome samples and syntax structures used to encode the monochrome samples. When a picture is encoded to a color plane that is split according to color components, a CTU may be a unit including the corresponding picture and syntax structures used to encode samples of the picture.

A CTB may be split into a M×N coding block including M×N samples, wherein M and N are integers.

When a picture has sample arrays for Y, Cr, and Cb components, a coding unit (CU) may be a unit including a coding block of a luma sample, two coding blocks of chroma samples corresponding to the luma sample, and syntax structures used to encode the luma sample and the chroma samples. When a picture is a monochrome picture, a CU may be a unit including a coding block of monochrome samples and syntax structures used to encode the monochrome samples. When a picture is encoded to a color plane that is split according to color components, a CU may be a unit including the corresponding picture and syntax structures used to encode samples of the picture.

As described above, a coding tree block may be distinguished from a coding tree unit, and a coding block may also be distinguished from a coding unit. That is, a coding unit (a coding tree unit) means a data structure including a coding block (coding tree block) including a corresponding sample and a syntax structure corresponding to the sample. However, because it will be understood by one of ordinary skill in the art that a coding unit (coding tree unit) or a coding block (coding tree block) indicates a block of a predetermined size including a predetermined number of samples, a coding tree block and a coding tree unit or a coding block and a coding unit will be referred to indiscriminatingly unless there are special reasons.

An image may be split into coding tree units. A size of a coding tree unit may be determined based on information acquired from a bit stream. A shape of the coding tree unit may be a square. However, the shape of the coding tree unit is not limited to a square.

For example, information about a maximum size of a luma coding block may be acquired from a bit stream. For example, a maximum size of a luma coding block represented by information about the maximum size of the luma coding block may be one of 4×4, 8×8, 16×16, 32×32, 64×64, 128×128, and 256×256.

For example, information about a maximum size of a luma coding block allowing a binary split and a difference in size between luma blocks may be acquired from a bit stream. The information about the difference in size between luma blocks may represent a difference in size between a luma coding tree unit and a luma coding tree unit allowing a binary split. By combining information about a maximum size of a luma coding block allowing a binary split, acquired from a bit stream, with information about a difference in size between luma blocks, a size of a luma coding tree unit may be determined. The size of the luma coding tree unit may be used to determine a size of a chroma coding tree unit. For example, when a ratio of Y:Cb:Cr is 4:2:0 according to a color format, a size of a chroma block may be half a size of a luma block, and likewise, a size of a chroma coding tree unit may be half a size of a luma coding tree unit.

According to an embodiment, because the information about the maximum size of the luma coding block allowing the binary split is acquired from a bit stream, the maximum size of the luma coding block allowing the binary split may vary. Unlike this, a maximum size of a luma coding block allowing a ternary split may be fixed. For example, a maximum size of a luma coding block allowing a ternary split in a I slice may be 32×32, and a maximum size of a luma coding block allowing a ternary split in a P slice or a B slice may be 64×64.

Also, a coding tree unit may be hierarchically split into coding units based on split shape mode information acquired from a bit stream. As the split shape mode information, at least one of information about whether a quad split is to be performed, information about whether a multi split is to be performed, split direction information, and split type information may be acquired from the bit stream.

For example, the information about whether a quad split is to be performed may represent whether or not a current coding unit is to be quad-split (QUAD_SPLIT).

When the current coding unit is to be not quad-split, the information about whether a multi split is to be performed may represent whether the current coding unit is to be no longer split (NO_SPLIT) or to be binary/ternary-split.

When the current coding unit is to be binary/ternary-split, the split direction information may represent that the current coding unit is split in one of a horizontal direction or a vertical direction.

When the current coding unit is split in one of a horizontal direction or a vertical direction, the split type information may represent that the current coding unit is binary- or ternary-split.

According to the split direction information and the split type information, a split mode of the current coding unit may be determined. A split mode of when the current coding unit is binary-split in the horizontal direction may be determined as a binary horizontal split SPLIT_BT_HOR, a split mode of when the current coding unit is ternary-split in the horizontal direction may be determined as a ternary horizontal split SPLIT_TT_HOR, a split mode of when the current coding unit is binary-split in the vertical direction may be determined as a binary vertical split SPLIT_BT_VER, a split mode of when the current coding unit is ternary-split in the vertical direction may be determined as a ternary vertical split SPLIT_BT_VER.

The image decoding device 100 may acquire split shape mode information as an bin string from a bit stream. The bit stream received by the image decoding device 100 may have a format including a fixed length binary code, a unary code, a truncated unary code, a predetermined binary code, etc. The bin string may be configured by representing information as an arrangement of binary numbers. The bin string may be configured with at least one bit. The image decoding device 100 may acquire split shape mode information corresponding to the bin string based on a split rule. The image decoding device 100 may determine whether to quad-split a coding unit, whether not to split a coding unit, or a split direction and a split type, based on the bin string.

The coding unit may be smaller than or equal to a coding tree unit. For example, the coding tree unit may be one of coding units because it is a coding unit having a maximum size. When the split shape mode information for the coding tree unit represents no split, a coding unit determined from the coding tree unit may have the same size as the coding tree unit. When the split shape mode information for the coding tree unit represents a split, the coding tree unit may be split into a plurality of coding units. When the split shape mode information for the coding units represents a split, the coding units may be further split into a plurality of coding units of a smaller size. However, splitting an image is not limited to this, and a coding tree unit may be not distinguished from a coding unit. Splitting a coding unit will be described in more detail with reference to FIGS. 3 to 16, later.

Also, at least one prediction block for prediction may be determined from a coding unit. The prediction block may be equal to or smaller than the coding unit. Also, at least one transform block for transformation may be determined from a coding unit. The transform block may be equal to or smaller than the coding unit.

A shape and size of the transform block may be not associated with those of the prediction block.

According to another embodiment, prediction may be performed by using a coding unit as a prediction block. Also, transformation may be performed by using a coding unit as a transform block.

Splitting a coding unit will be described in more detail with reference to FIGS. 3 to 16, later. In the disclosure, a current block and an adjacent block may represent one of a coding tree unit, a coding unit, a prediction block, and a transform block. Also, a current block or a current coding unit may be a block that is being currently decoded or encoded or a block that is being currently split. The adjacent block may be a block reconstructed earlier than the current block. The adjacent block may be spatially or temporally adjacent to the current block. The adjacent block may be located in one of left-lower, left, left-upper, upper, right-upper, right, and right-lower sides of the current block.

FIG. 3 shows a process in which the image decoding device 100 splits a current coding unit to determine at least one coding unit, according to an embodiment.

A block shape may include 4N×4N, 4N×2N, 2N×4N, 4N×N, N×4N, 32N×N, N×32N, 16N×N, N×16N, 8N×N or N×8N. Herein, N may be a positive integer. Block shape information may be information representing at least one of a shape, a direction, a ratio of width and height, or a size of a coding unit.

The shape of the coding unit may include a square and a non-square. When a width and height of a coding unit have the same length (that is, when a block shape of the coding unit is 4N×4N), the image decoding device 100 may determine block shape information of the coding unit as a square. The image decoding device 100 may determine a shape of a coding unit as a non-square.

When a width and height of a coding unit have different lengths (that is, when a block shape of the coding unit is 4N×2N, 2N×4N, 4N×N, N×4N, 32N×N, N×32N, 16N×N, N×16N, 8N×N or N×8N), the image decoding device 100 may determine block shape information of the coding unit as a non-square. When a shape of a coding unit is a non-square, the image decoding device 100 may determine a ratio of width and height among block shape information of the coding unit as at least one of 1:2, 2:1, 1:4, 4:1, 1:8, 8:1, 1:16, 16:1, 1:32, and 32:1. Also, the image decoding device 100 may determine whether a coding unit is located in the horizontal direction or in the vertical direction, based on a width length and a height length of the coding unit. Also, the image decoding device 100 may determine a size of a coding unit based on at least one of a width length of the coding unit, a height length of the coding unit, or an area of the coding unit.

According to an embodiment, the image decoding device 100 may determine a shape of a coding unit based on block shape information, and determine a split shape of the coding unit based on split shape mode information. That is, a split method of a coding unit represented by split shape mode information may be determined according to a block shape represented by block shape information that the image decoding device 100 uses.

The image decoding device 100 may acquire the split shape mode information from a bit stream, although not limited thereto. However, the image decoding device 100 and the image encoding device 2200 may determine promised split shape mode information based on the block shape information. The image decoding device 100 may determine promised split shape mode information for a coding tree unit or a minimum coded unit. For example, the image decoding device 100 may determine split shape mode information for the coding tree unit as a quad split. Also, the image decoding device 100 may determine split shape mode information for the minimum coded unit as “no-split”. More specifically, the image decoding device 100 may determine a size of a coding tree unit as 256×256. The image decoding device 100 may determine the promised split shape mode information as a quad split. The quad split may be a split shape mode of halving both a width and height of a coding unit. The image decoding device 100 may acquire coding units ranging from a coding tree unit of a 256×256 size to a coding unit of a 128×128 size based on the split shape mode information. Also, the image decoding device 100 may determine a size of the minimum coded unit as 4×4. The image decoding device 100 may acquire split shape mode information representing “no-split” for the minimum coded unit.

According to an embodiment, the image decoding device 100 may use block shape information representing that a current coding unit is a square. For example, the image decoding device 100 may determine whether not to split the coding unit having the square shape or whether to split the coding unit having the square shape in the vertical direction, in the horizontal direction or into four coding units, based on the split shape mode information. Referring to FIG. 3, when block shape information of a current coding unit 300 represents a square, the decoder 120 may not split a coding unit 310a having the same size as the current coding unit 300 according to split shape mode information representing no-split, or the decoder 120 may determine coding units 310b, 310c, 310d, 310e, and 310f split based on split shape mode information representing a predetermined split method.

Referring to FIG. 3, according to an embodiment, the image decoding device 100 may determine two coding units 310b resulting from splitting the current coding unit 300 in the vertical direction based on split shape mode information representing a vertical split. The image decoding device 100 may determine two coding units 310c resulting from splitting the current coding unit 300 in the horizontal direction based on split shape mode information representing a horizontal split. The image decoding device 100 may determine four coding units 310d resulting from splitting the current coding unit 300 in the vertical direction and in the horizontal direction based on split shape mode information representing a vertical split and a horizontal split. According to an embodiment, the image decoding device 100 may determine three coding units 310e resulting from splitting the current coding unit 300 in the vertical direction based on split shape mode information representing a vertical ternary-split. The image decoding device 100 may determine three coding units 310f resulting from splitting the current coding unit 300 in the horizontal direction based on split shape mode information representing a horizontal ternary-split. However, split shapes into which a coding unit having a square shape is capable of being split are not limited to the above-described shapes, and may include various other shapes that may be represented by split shape mode information. Predetermined split shapes into which a coding unit having a square shape is split will be described in detail through various embodiments, later.

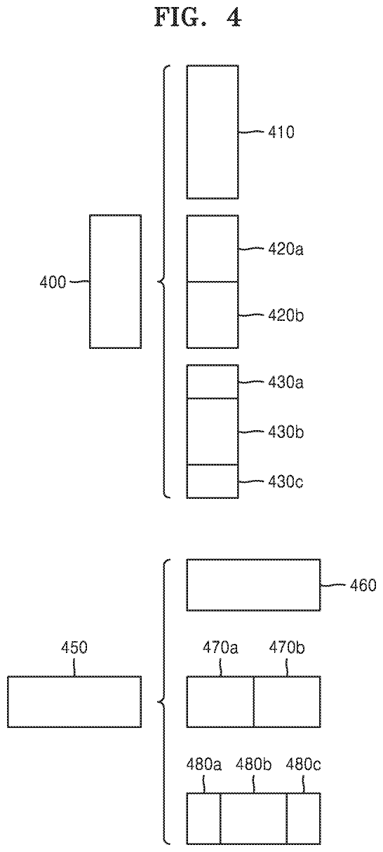

FIG. 4 shows a process in which the image decoding device 100 splits a coding unit having a non-square shape to determine at least one coding unit, according to an embodiment.

According to an embodiment, the image decoding device 100 may use block shape information representing that a current coding unit is a non-square. The image decoding device 100 may determine whether not to split the current coding unit having the non-square shape or whether to split the current coding unit having the non-square shape by a predetermined method, according to split shape mode information. Referring to FIG. 4, when block shape information of a current coding unit 400 or 450 represents a non-square, the image decoding device 100 may determine a coding unit 410 or 460 having the same size as the current coding unit 400 or 450 according to split shape mode information representing no-split, or the image decoding device 100 may determine coding units 420a, 420b, 430a, 430b, 430c, 470a, 470b, 480a, 480b, and 480c split based on split shape mode information representing a predetermined split method. The predetermined split method for splitting a coding unit having a non-square shape will be described in detail through various embodiments, later.

According to an embodiment, the image decoding device 100 may determine a split shape of a coding unit by using split shape mode information, and, in this case, the split shape mode information may represent a number of at least one coding unit into which the coding unit is split. Referring to FIG. 4, when split shape mode information represents that the current coding unit 400 or 450 is split into two coding units, the image decoding device 100 may split the current coding unit 400 or 450 based on the split shape mode information to determine two coding units 420a and 420b or 470a and 470b included in the current coding unit 400 or 450.

According to an embodiment, when the image decoding device 100 splits the current coding unit 400 or 450 having the non-square shape based on the split shape mode information, the image decoding device 100 may split the current coding unit 400 or 450 having the non-square shape considering a position of a longer side of the current coding unit 400 or 450. For example, the image decoding device 100 may split the current coding unit 400 or 450 in a direction of splitting the longer side of the current coding unit 400 or 450 considering a shape of the current coding unit 400 or 450 to determine a plurality of coding units.

According to an embodiment, when the split shape mode information represents a split (a ternary split) of a coding unit into an odd number of blocks, the image decoding device 100 may determine an odd number of coding units included in the current coding unit 400 or 450. For example, when the split shape mode information represents a split (a ternary split) of the current coding unit 400 or 450 into three coding units, the image decoding device 100 may split the current coding unit 400 or 450 into three coding units 430a, 430b and 430c or 480a, 480b and 480c.

According to an embodiment, a ratio of width and height of the current coding unit 400 or 450 may be 4:1 or 1:4. When the ratio of width and height is 4:1, block shape information may represent the horizontal direction because a length of the width is longer than a length of the height. When the ratio of width and height is 1:4, block shape information may represent the vertical direction because a length of the width is shorter than a length of the height. The image decoding device 100 may determine a split of the current coding unit 400 or 450 into an odd number of blocks based on the split shape mode information. Also, the image decoding device 100 may determine a split direction of the current coding unit 400 or 450 based on block shape information of the current coding unit 400 or 450. For example, when the current coding unit 400 is located in the vertical direction, the image decoding device 100 may split the current coding unit 400 in the horizontal direction to determine the coding units 430a, 430b, and 430c. Also, when the current coding unit 400 is located in the horizontal direction, the image decoding device 100 may split the current coding unit 400 in the vertical direction to determine the coding units 480a, 480b, and 480c.

According to an embodiment, the image decoding apparatus 100 may determine the odd number of coding units included in the current coding unit 400 or 450, and not all the determined coding units may have the same size. For example, a predetermined coding unit 430b or 480b from among the determined odd number of coding units 430a, 430b, and 430c, or 480a, 480b, and 480c may have a size different from the size of the other coding units 430a and 430c, or 480a and 480c. That is, coding units which may be determined by splitting the current coding unit 400 or 450 may have multiple sizes and, in some cases, all of the odd number of coding units 430a, 430b, and 430c, or 480a, 480b, and 480c may have different sizes.

According to an embodiment, when the split shape mode information indicates to split a coding unit into the odd number of blocks, the image decoding apparatus 100 may determine the odd number of coding units included in the current coding unit 400 or 450, and in addition, may put a predetermined restriction on at least one coding unit from among the odd number of coding units generated by splitting the current coding unit 400 or 450. Referring to FIG. 4, the image decoding apparatus 100 may set a decoding process regarding the coding unit 430b or 480b located at the center among the three coding units 430a, 430b, and 430c or 480a, 480b, and 480c generated as the current coding unit 400 or 450 is split to be different from that of the other coding units 430a and 430c, or 480a or 480c. For example, the image decoding apparatus 100 may restrict the coding unit 430b or 480b at the center location to be no longer split or to be split only a predetermined number of times, unlike the other coding units 430a and 430c, or 480a and 480c.

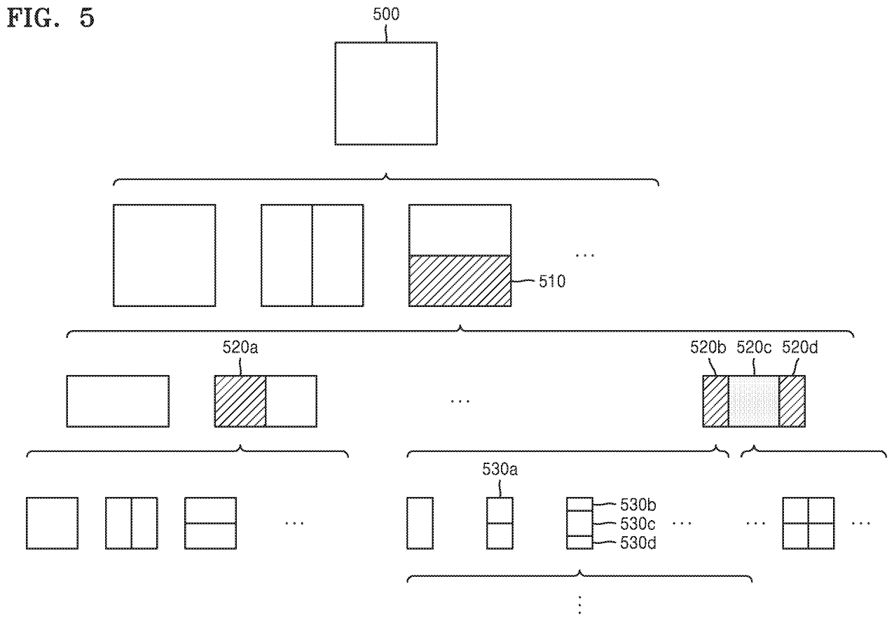

FIG. 5 illustrates a process, performed by the image decoding apparatus 100, of splitting a coding unit based on at least one of block shape information and split shape mode information, according to an embodiment.

According to an embodiment, the image decoding apparatus 100 may determine to split or not to split a square first coding unit 500 into coding units, based on at least one of the block shape information and the split shape mode information. According to an embodiment, when the split shape mode information indicates to split the first coding unit 500 in a horizontal direction, the image decoding apparatus 100 may determine a second coding unit 510 by splitting the first coding unit 500 in a horizontal direction. A first coding unit, a second coding unit, and a third coding unit used according to an embodiment are terms used to understand a relation before and after splitting a coding unit. For example, a second coding unit may be determined by splitting a first coding unit, and a third coding unit may be determined by splitting the second coding unit. It will be understood that the structure of the first coding unit, the second coding unit, and the third coding unit follows the above descriptions.

According to an embodiment, the image decoding apparatus 100 may determine to split or not to split the determined second coding unit 510 into coding units, based on the split shape mode information. Referring to FIG. 5, the image decoding apparatus 100 may or may not split the non-square second coding unit 510, which is determined by splitting the first coding unit 500, into one or more third coding units 520a, or 520b, 520c, and 520d based on the split shape mode information. The image decoding apparatus 100 may obtain the split shape mode information, and may obtain a plurality of various-shaped second coding units (e.g., 510) by splitting the first coding unit 500, based on the obtained split shape mode information, and the second coding unit 510 may be split by using a splitting method of the first coding unit 500 based on the split shape mode information. According to an embodiment, when the first coding unit 500 is split into the second coding units 510 based on the split shape mode information of the first coding unit 500, the second coding unit 510 may also be split into the third coding units 520a, or 520b, 520c, and 520d based on the split shape mode information of the second coding unit 510. That is, a coding unit may be recursively split based on the split shape mode information of each coding unit. Therefore, a square coding unit may be determined by splitting a non-square coding unit, and a non-square coding unit may be determined by recursively splitting the square coding unit.

Referring to FIG. 5, a predetermined coding unit from among the odd number of third coding units 520b, 520c, and 520d determined by splitting the non-square second coding unit 510 (e.g., a coding unit at a center location or a square coding unit) may be recursively split. According to an embodiment, the square third coding unit 520b from among the odd number of third coding units 520b, 520c, and 520d may be split in a horizontal direction into a plurality of fourth coding units. A non-square fourth coding unit 530b or 530d from among a plurality of fourth coding units 530a, 530b, 530c, and 530d may be split into a plurality of coding units again. For example, the non-square fourth coding unit 530b or 530d may be split into the odd number of coding units again. A method that may be used to recursively split a coding unit will be described below in relation to various embodiments.

According to an embodiment, the image decoding apparatus 100 may split each of the third coding units 520a, or 520b, 520c, and 520d into coding units, based on the split shape mode information. Also, the image decoding apparatus 100 may determine not to split the second coding unit 510 based on the split shape mode information. According to an embodiment, the image decoding apparatus 100 may split the non-square second coding unit 510 into the odd number of third coding units 520b, 520c, and 520d. The image decoding apparatus 100 may put a predetermined restriction on a predetermined third coding unit from among the odd number of third coding units 520b, 520c, and 520d. For example, the image decoding apparatus 100 may restrict the third coding unit 520c at a center location from among the odd number of third coding units 520b, 520c, and 520d to be no longer split or to be split a settable number of times.

Referring to FIG. 5, the image decoding apparatus 100 may restrict the third coding unit 520c, which is at the center location from among the odd number of third coding units 520b, 520c, and 520d included in the non-square second coding unit 510, to be no longer split, to be split by using a predetermined splitting method (e.g., split into only four coding units or split by using a splitting method of the second coding unit 510), or to be split only a predetermined number of times (e.g., split only n times (where n>0)). However, the restrictions on the third coding unit 520c at the center location are not limited to the above-described examples, and may include various restrictions for decoding the third coding unit 520c at the center location differently from the other third coding units 520b and 520d.

According to an embodiment, the image decoding apparatus 100 may obtain the split shape mode information, which is used to split a current coding unit, from a predetermined location in the current coding unit.

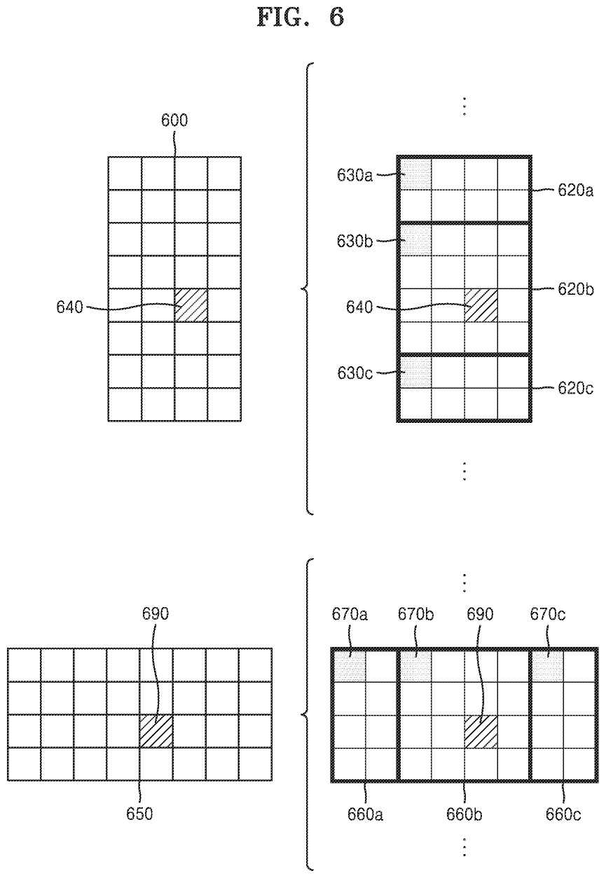

FIG. 6 illustrates a method, performed by the image decoding apparatus 100, of determining a predetermined coding unit from among an odd number of coding units, according to an embodiment.

Referring to FIG. 6, split shape mode information of a current coding unit 600 or 650 may be obtained from a sample of a predetermined location (e.g., a sample 640 or 690 of a center location) from among a plurality of samples included in the current coding unit 600 or 650. However, the predetermined location in the current coding unit 600, from which at least one piece of the split shape mode information may be obtained, is not limited to the center location in FIG. 6, and may include various locations included in the current coding unit 600 (e.g., top, bottom, left, right, upper left, lower left, upper right, and lower right locations). The image decoding apparatus 100 may obtain the split shape mode information from the predetermined location and may determine to split or not to split the current coding unit into various-shaped and various-sized coding units.

According to an embodiment, when the current coding unit is split into a predetermined number of coding units, the image decoding apparatus 100 may select one of the coding units. Various methods may be used to select one of a plurality of coding units, as will be described below in relation to various embodiments.

According to an embodiment, the image decoding apparatus 100 may split the current coding unit into a plurality of coding units, and may determine a coding unit at a predetermined location.

According to an embodiment, image decoding apparatus 100 may use information indicating locations of the odd number of coding units, to determine a coding unit at a center location from among the odd number of coding units. Referring to FIG. 6, the image decoding apparatus 100 may determine the odd number of coding units 620a, 620b, and 620c or the odd number of coding units 660a, 660b, and 660c by splitting the current coding unit 600 or the current coding unit 650. The image decoding apparatus 100 may determine the middle coding unit 620b or the middle coding unit 660b by using information about the locations of the odd number of coding units 620a, 620b, and 620c or the odd number of coding units 660a, 660b, and 660c. For example, the image decoding apparatus 100 may determine the coding unit 620b of the center location by determining the locations of the coding units 620a, 620b, and 620c based on information indicating locations of predetermined samples included in the coding units 620a, 620b, and 620c. In detail, the image decoding apparatus 100 may determine the coding unit 620b at the center location by determining the locations of the coding units 620a, 620b, and 620c based on information indicating locations of upper left samples 630a, 630b, and 630c of the coding units 620a, 620b, and 620c.

According to an embodiment, the information indicating the locations of the upper left samples 630a, 630b, and 630c, which are included in the coding units 620a, 620b, and 620c, respectively, may include information about locations or coordinates of the coding units 620a, 620b, and 620c in a picture. According to an embodiment, the information indicating the locations of the upper left samples 630a, 630b, and 630c, which are included in the coding units 620a, 620b, and 620c, respectively, may include information indicating widths or heights of the coding units 620a, 620b, and 620c included in the current coding unit 600, and the widths or heights may correspond to information indicating differences between the coordinates of the coding units 620a, 620b, and 620c in the picture. That is, the image decoding apparatus 100 may determine the coding unit 620b at the center location by directly using the information about the locations or coordinates of the coding units 620a, 620b, and 620c in the picture, or by using the information about the widths or heights of the coding units, which correspond to the difference values between the coordinates.

According to an embodiment, information indicating the location of the upper left sample 630a of the upper coding unit 620a may include coordinates (xa, ya), information indicating the location of the upper left sample 630b of the middle coding unit 620b may include coordinates (xb, yb), and information indicating the location of the upper left sample 630c of the lower coding unit 620c may include coordinates (xc, yc). The image decoding apparatus 100 may determine the middle coding unit 620b by using the coordinates of the upper left samples 630a, 630b, and 630c which are included in the coding units 620a, 620b, and 620c, respectively. For example, when the coordinates of the upper left samples 630a, 630b, and 630c are sorted in an ascending or descending order, the coding unit 620b including the coordinates (xb, yb) of the sample 630b at a center location may be determined as a coding unit at a center location from among the coding units 620a, 620b, and 620c determined by splitting the current coding unit 600. However, the coordinates indicating the locations of the upper left samples 630a, 630b, and 630c may include coordinates indicating absolute locations in the picture, or may use coordinates (dxb, dyb) indicating a relative location of the upper left sample 630b of the middle coding unit 620b and coordinates (dxc, dyc) indicating a relative location of the upper left sample 630c of the lower coding unit 620c with reference to the location of the upper left sample 630a of the upper coding unit 620a. A method of determining a coding unit at a predetermined location by using coordinates of a sample included in the coding unit, as information indicating a location of the sample, is not limited to the above-described method, and may include various arithmetic methods capable of using the coordinates of the sample.

According to an embodiment, the image decoding apparatus 100 may split the current coding unit 600 into a plurality of coding units 620a, 620b, and 620c, and may select one of the coding units 620a, 620b, and 620c based on a predetermined criterion. For example, the image decoding apparatus 100 may select the coding unit 620b, which has a size different from that of the others, from among the coding units 620a, 620b, and 620c.

According to an embodiment, the image decoding apparatus 100 may determine the width or height of each of the coding units 620a, 620b, and 620c by using the coordinates (xa, ya) that is the information indicating the location of the upper left sample 630a of the upper coding unit 620a, the coordinates (xb, yb) that is the information indicating the location of the upper left sample 630b of the middle coding unit 620b, and the coordinates (xc, yc) that is the information indicating the location of the upper left sample 630c of the lower coding unit 620c. The image decoding apparatus 100 may determine the respective sizes of the coding units 620a, 620b, and 620c by using the coordinates (xa, ya), (xb, yb), and (xc, yc) indicating the locations of the coding units 620a, 620b, and 620c. According to an embodiment, the image decoding apparatus 100 may determine the width of the upper coding unit 620a to be the width of the current coding unit 600. The image decoding apparatus 100 may determine the height of the upper coding unit 620a to be yb-ya. According to an embodiment, the image decoding apparatus 100 may determine the width of the middle coding unit 620b to be the width of the current coding unit 600. The image decoding apparatus 100 may determine the height of the middle coding unit 620b to be yc-yb. According to an embodiment, the image decoding apparatus 100 may determine the width or height of the lower coding unit 620c by using the width or height of the current coding unit 600 or the widths or heights of the upper and middle coding units 620a and 620b. The image decoding apparatus 100 may determine a coding unit, which has a size different from that of the others, based on the determined widths and heights of the coding units 620a to 620c. Referring to FIG. 6, the image decoding apparatus 100 may determine the middle coding unit 620b, which has a size different from the size of the upper and lower coding units 620a and 620c, as the coding unit of the predetermined location. However, the above-described method, performed by the image decoding apparatus 100, of determining a coding unit having a size different from the size of the other coding units merely corresponds to an example of determining a coding unit at a predetermined location by using the sizes of coding units, which are determined based on coordinates of samples, and thus various methods of determining a coding unit at a predetermined location by comparing the sizes of coding units, which are determined based on coordinates of predetermined samples, may be used.

The image decoding device 100 may determine widths or heights of the coding units 660a, 660b, and 660c by using coordinates (xd, yd) being information representing a position of a left-upper sample 670a of the coding unit 660a located in a left side, coordinates (xe, ye) being information representing a position of a left-upper sample 670b of the coding unit 660b located in a center, and coordinates (xf, yf) being information representing a position of a left-upper sample 670c of the coding unit 660c located in a right side. The image decoding device 100 may determine sizes of the coding units 660a, 660b, and 660c by using the coordinates (xd, yd), (xe, ye), and (xf, yf) representing the positions of the coding units 660a, 660b, and 660c.

According to an embodiment, the image decoding device 100 may determine the width of the coding unit 660a located in the left side as xe-xd. The image decoding device 100 may determine the height of the coding unit 660a located to the left as a height of the current coding unit 650. According to an embodiment, the image decoding device 100 may determine the width of the coding unit 660b located in the center as xf-xe. The image decoding device 100 may determine the height of the coding unit 660b located in the center as a height of the current coding unit 600. According to an embodiment, the image decoding device 100 may determine the width or height of the encoding unit 660c located in the right side by using the width or height of the current coding unit 650 and the widths and heights of the coding unit 660a located in the left side and the coding unit 660b located in the center. The image decoding device 100 may determine another coding unit and a coding unit having another size, based on the determined widths and heights of the coding units 660a, 660b, and 660c. Referring to FIG. 6, the image decoding device 100 may determine the coding unit 660b located in the center and having a size that is different from those of the coding unit 660a located in the left side and the coding unit 660c located in the right side, as a coding unit located at a predetermined position. However, a process in which the image decoding device 100 as described above determines a coding unit having a size that is different from those of other coding units is an embodiment of determining a coding unit located at a predetermined position by using a size of the coding unit determined based on coordinates of samples. Therefore, various processes of determining a coding unit located at a predetermined position by comparing sizes of coding units determined according to coordinates of predetermined samples may be used.

However, locations of samples considered to determine locations of coding units are not limited to the above-described upper left locations, and information about arbitrary locations of samples included in the coding units may be used.

According to an embodiment, the image decoding apparatus 100 may select a coding unit at a predetermined location from among an odd number of coding units determined by splitting the current coding unit, considering the shape of the current coding unit. For example, when the current coding unit has a non-square shape, a width of which is longer than a height, the image decoding apparatus 100 may determine the coding unit at the predetermined location in a horizontal direction. That is, the image decoding apparatus 100 may determine one of coding units at different locations in a horizontal direction and put a restriction on the coding unit. When the current coding unit has a non-square shape, a height of which is longer than a width, the image decoding apparatus 100 may determine the coding unit at the predetermined location in a vertical direction. That is, the image decoding apparatus 100 may determine one of coding units at different locations in a vertical direction and may put a restriction on the coding unit.

According to an embodiment, the image decoding apparatus 100 may use information indicating respective locations of an even number of coding units, to determine the coding unit at the predetermined location from among the even number of coding units. The image decoding apparatus ′00 may determine an even number of coding units by splitting (binary-splitting) the current coding unit, and may determine the coding unit at the predetermined location by using the information about the locations of the even number of coding units. An operation related thereto may correspond to the operation of determining a coding unit at a predetermined location (e.g., a center location) from among an odd number of coding units, which has been described in detail above in relation to FIG. 6, and thus detailed descriptions thereof are not provided here.

According to an embodiment, when a non-square current coding unit is split into a plurality of coding units, predetermined information about a coding unit at a predetermined location may be used in a splitting operation to determine the coding unit at the predetermined location from among the plurality of coding units. For example, the image decoding apparatus 100 may use at least one of block shape information and split shape mode information, which is stored in a sample included in a middle coding unit, in a splitting operation to determine a coding unit at a center location from among the plurality of coding units determined by splitting the current coding unit.

Referring to FIG. 6, the image decoding apparatus 100 may split the current coding unit 600 into the plurality of coding units 620a, 620b, and 620c based on the split shape mode information, and may determine the coding unit 620b at a center location from among the plurality of the coding units 620a, 620b, and 620c. Furthermore, the image decoding apparatus 100 may determine the coding unit 620b at the center location, in consideration of a location from which the split shape mode information is obtained. That is, the split shape mode information of the current coding unit 600 may be obtained from the sample 640 at a center location of the current coding unit 600 and, when the current coding unit 600 is split into the plurality of coding units 620a, 620b, and 620c based on the split shape mode information, the coding unit 620b including the sample 640 may be determined as the coding unit at the center location. However, information used to determine the coding unit at the center location is not limited to the split shape mode information, and various types of information may be used to determine the coding unit at the center location.

According to an embodiment, predetermined information for identifying the coding unit at the predetermined location may be obtained from a predetermined sample included in a coding unit to be determined. Referring to FIG. 6, the image decoding apparatus 100 may use the split shape mode information, which is obtained from a sample at a predetermined location in the current coding unit 600 (e.g., a sample at a center location of the current coding unit 600) to determine a coding unit at a predetermined location from among the plurality of the coding units 620a, 620b, and 620c determined by splitting the current coding unit 600 (e.g., a coding unit at a center location from among a plurality of split coding units). That is, the image decoding apparatus 100 may determine the sample at the predetermined location by considering a block shape of the current coding unit 600, determine the coding unit 620b including a sample, from which predetermined information (e.g., the split shape mode information) may be obtained, from among the plurality of coding units 620a, 620b, and 620c determined by splitting the current coding unit 600, and may put a predetermined restriction on the coding unit 620b. Referring to FIG. 6, according to an embodiment, the image decoding apparatus 100 may determine the sample 640 at the center location of the current coding unit 600 as the sample from which the predetermined information may be obtained, and may put a predetermined restriction on the coding unit 620b including the sample 640, in a decoding operation. However, the location of the sample from which the predetermined information may be obtained is not limited to the above-described location, and may include arbitrary locations of samples included in the coding unit 620b to be determined for a restriction.

According to an embodiment, the location of the sample from which the predetermined information may be obtained may be determined based on the shape of the current coding unit 600. According to an embodiment, the block shape information may indicate whether the current coding unit has a square or non-square shape, and the location of the sample from which the predetermined information may be obtained may be determined based on the shape. For example, the image decoding apparatus 100 may determine a sample located on a boundary for splitting at least one of a width and height of the current coding unit in half, as the sample from which the predetermined information may be obtained, by using at least one of information about the width of the current coding unit and information about the height of the current coding unit. As another example, when the block shape information of the current coding unit indicates a non-square shape, the image decoding apparatus 100 may determine one of samples adjacent to a boundary for splitting a long side of the current coding unit in half, as the sample from which the predetermined information may be obtained.

According to an embodiment, when the current coding unit is split into a plurality of coding units, the image decoding apparatus 100 may use the split shape mode information to determine a coding unit at a predetermined location from among the plurality of coding units. According to an embodiment, the image decoding apparatus 100 may obtain the split shape mode information from a sample at a predetermined location in a coding unit, and split the plurality of coding units, which are generated by splitting the current coding unit, by using the split shape mode information, which is obtained from the sample of the predetermined location in each of the plurality of coding units. That is, a coding unit may be recursively split based on the split shape mode information, which is obtained from the sample at the predetermined location in each coding unit. An operation of recursively splitting a coding unit has been described above in relation to FIG. 5, and thus detailed descriptions thereof will not be provided here.

According to an embodiment, the image decoding apparatus 100 may determine one or more coding units by splitting the current coding unit, and may determine an order of decoding the one or more coding units, based on a predetermined block (e.g., the current coding unit).

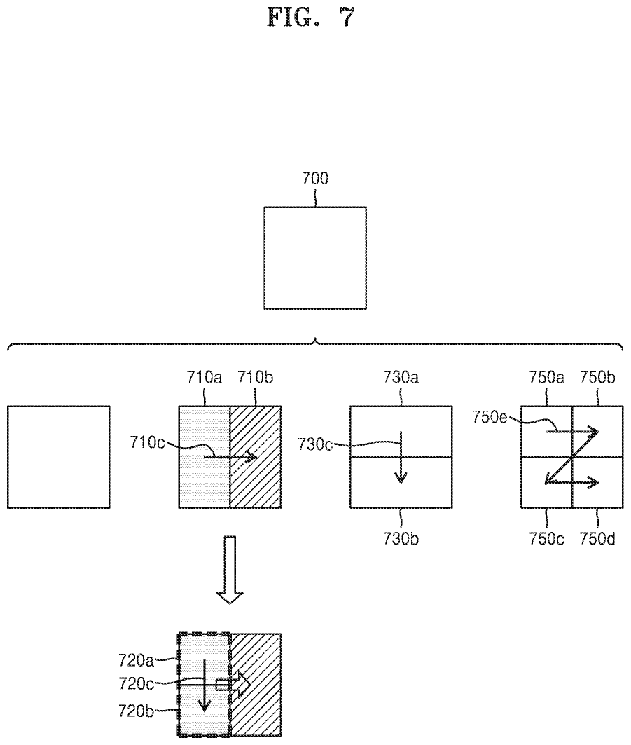

FIG. 7 illustrates an order of processing a plurality of coding units when the image decoding apparatus 100 determines the plurality of coding units by splitting a current coding unit, according to an embodiment.

According to an embodiment, the image decoding apparatus 100 may determine second coding units 710a and 710b by splitting a first coding unit 700 in a vertical direction, determine second coding units 730a and 730b by splitting the first coding unit 700 in a horizontal direction, or determine second coding units 750a to 750d by splitting the first coding unit 700 in vertical and horizontal directions, based on split shape mode information.

Referring to FIG. 7, the image decoding apparatus 100 may determine to process the second coding units 710a and 710b, which are determined by splitting the first coding unit 700 in a vertical direction, in a horizontal direction order 710c. The image decoding apparatus 100 may determine to process the second coding units 730a and 730b, which are determined by splitting the first coding unit 700 in a horizontal direction, in a vertical direction order 730c. The image decoding apparatus 100 may determine to process the second coding units 750a to 750d, which are determined by splitting the first coding unit 700 in vertical and horizontal directions, in a predetermined order for processing coding units in a row and then processing coding units in a next row (e.g., in a raster scan order or Z-scan order 750e).

According to an embodiment, the image decoding apparatus 100 may recursively split coding units. Referring to FIG. 7, the image decoding apparatus 100 may determine the plurality of coding units 710a and 710b, 730a and 730b, or 750a to 750d by splitting the first coding unit 700, and recursively split each of the determined plurality of coding units 710b, 730a and 730b, or 750a to 750d. A splitting method of the plurality of coding units 710b, 730a and 730b, or 750a to 750d may correspond to a splitting method of the first coding unit 700. As such, each of the plurality of coding units 710b, 730a and 730b, or 750a to 750d may be independently split into a plurality of coding units. Referring to FIG. 7, the image decoding apparatus 100 may determine the second coding units 710a and 710b by splitting the first coding unit 700 in a vertical direction, and may determine to independently split or not to split each of the second coding units 710a and 710b.

According to an embodiment, the image decoding apparatus 100 may determine third coding units 720a and 720b by splitting the left second coding unit 710a in a horizontal direction, and may not split the right second coding unit 710b.

According to an embodiment, a processing order of coding units may be determined based on an operation of splitting a coding unit. In other words, a processing order of split coding units may be determined based on a processing order of coding units immediately before being split. The image decoding apparatus 100 may determine a processing order of the third coding units 720a and 720b determined by splitting the left second coding unit 710a, independently of the right second coding unit 710b. Because the third coding units 720a and 720b are determined by splitting the left second coding unit 710a in a horizontal direction, the third coding units 720a and 720b may be processed in a vertical direction order 720c. Because the left and right second coding units 710a and 710b are processed in the horizontal direction order 710c, the right second coding unit 710b may be processed after the third coding units 720a and 720b included in the left second coding unit 710a are processed in the vertical direction order 720c. An operation of determining a processing order of coding units based on a coding unit before being split is not limited to the above-described example, and various methods may be used to independently process coding units, which are split and determined to various shapes, in a predetermined order.

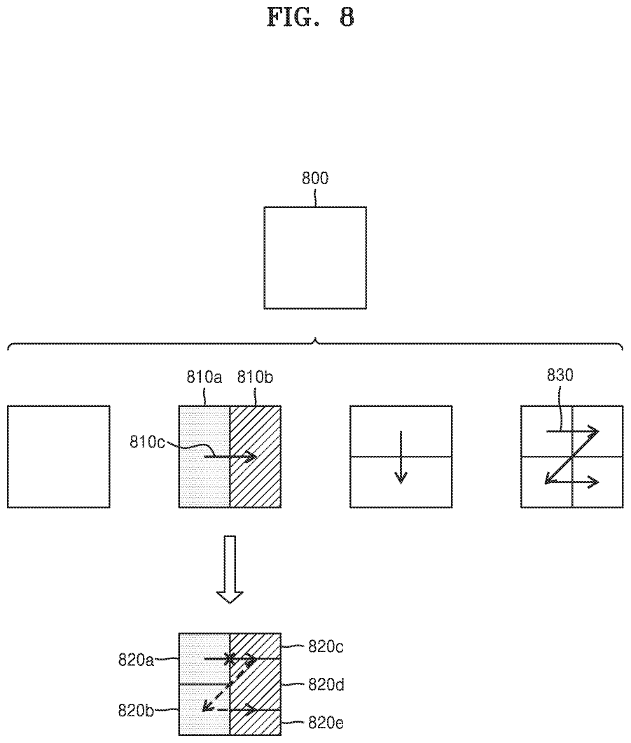

FIG. 8 illustrates a process, performed by the image decoding apparatus 100, of determining that a current coding unit is to be split into an odd number of coding units, when the coding units are not processable in a predetermined order, according to an embodiment.

According to an embodiment, the image decoding apparatus 100 may determine whether the current coding unit is split into an odd number of coding units, based on obtained split shape mode information. Referring to FIG. 8, a square first coding unit 800 may be split into non-square second coding units 810a and 810b, and the second coding units 810a and 810b may be independently split into third coding units 820a and 820b, and 820c to 820e. According to an embodiment, the image decoding apparatus 100 may determine the plurality of third coding units 820a and 820b by splitting the left second coding unit 810a in a horizontal direction, and may split the right second coding unit 810b into the odd number of third coding units 820c to 820e.

According to an embodiment, the image decoding apparatus 100 may determine whether any coding unit is split into an odd number of coding units, by determining whether the third coding units 820a and 820b, and 820c to 820e are processable in a predetermined order. Referring to FIG. 8, the image decoding apparatus 100 may determine the third coding units 820a and 820b, and 820c to 820e by recursively splitting the first coding unit 800. The image decoding apparatus 100 may determine whether any of the first coding unit 800, the second coding units 810a and 810b, and the third coding units 820a and 820b, and 820c to 820e are split into an odd number of coding units, based on at least one of the block shape information and the split shape mode information. For example, the right second coding unit 810b among the second coding units 810a and 810b may be split into an odd number of third coding units 820c, 820d, and 820e. A processing order of a plurality of coding units included in the first coding unit 800 may be a predetermined order (e.g., a Z-scan order 830), and the image decoding apparatus 100 may determine whether the third coding units 820c, 820d, and 820e, which are determined by splitting the right second coding unit 810b into an odd number of coding units, satisfy a condition for processing in the predetermined order.

According to an embodiment, the image decoding apparatus 100 may determine whether the third coding units 820a and 820b, and 820c to 820e included in the first coding unit 800 satisfy the condition for processing in the predetermined order, and the condition relates to whether at least one of a width and height of the second coding units 810a and 810b is split in half along a boundary of the third coding units 820a and 820b, and 820c to 820e. For example, the third coding units 820a and 820b determined when the height of the left second coding unit 810a of the non-square shape is split in half may satisfy the condition. It may be determined that the third coding units 820c to 820e do not satisfy the condition because the boundaries of the third coding units 820c to 820e determined when the right second coding unit 810b is split into three coding units are unable to split the width or height of the right second coding unit 810b in half. When the condition is not satisfied as described above, the image decoding apparatus 100 may determine disconnection of a scan order, and may determine that the right second coding unit 810b is split into an odd number of coding units, based on a result of the determination. According to an embodiment, when a coding unit is split into an odd number of coding units, the image decoding apparatus 100 may put a predetermined restriction on a coding unit at a predetermined location from among the split coding units. The restriction or the predetermined location has been described above in relation to various embodiments, and thus detailed descriptions thereof will not be provided herein.

FIG. 9 illustrates a process, performed by the image decoding apparatus 100, of determining at least one coding unit by splitting a first coding unit 900, according to an embodiment.

According to an embodiment, the image decoding apparatus 100 may split the first coding unit 900, based on split shape mode information, which is obtained through the receiver 110. The square first coding unit 900 may be split into four square coding units, or may be split into a plurality of non-square coding units. For example, referring to FIG. 9, when the split shape mode information indicates to split the first coding unit 900 into non-square coding units, the image decoding apparatus 100 may split the first coding unit 900 into a plurality of non-square coding units. In detail, when the split shape mode information indicates to determine an odd number of coding units by splitting the first coding unit 900 in a horizontal direction or a vertical direction, the image decoding apparatus 100 may split the square first coding unit 900 into an odd number of coding units, e.g., second coding units 910a, 910b, and 910c determined by splitting the square first coding unit 900 in a vertical direction or second coding units 920a, 920b, and 920c determined by splitting the square first coding unit 900 in a horizontal direction.

According to an embodiment, the image decoding apparatus 100 may determine whether the second coding units 910a, 910b, 910c, 920a, 920b, and 920c included in the first coding unit 900 satisfy a condition for processing in a predetermined order, and the condition relates to whether at least one of a width and height of the first coding unit 900 is split in half along a boundary of the second coding units 910a, 910b, 910c, 920a, 920b, and 920c. Referring to FIG. 9, because boundaries of the second coding units 910a, 910b, and 910c determined by splitting the square first coding unit 900 in a vertical direction do not split the height of the first coding unit 900 in half, it may be determined that the first coding unit 900 does not satisfy the condition for processing in the predetermined order. In addition, because boundaries of the second coding units 920a, 920b, and 920c determined by splitting the square first coding unit 900 in a horizontal direction do not split the width of the first coding unit 900 in half, it may be determined that the first coding unit 900 does not satisfy the condition for processing in the predetermined order. When the condition is not satisfied as described above, the image decoding apparatus 100 may decide disconnection of a scan order, and may determine that the first coding unit 900 is split into an odd number of coding units, based on a result of the decision. According to an embodiment, when a coding unit is split into an odd number of coding units, the image decoding apparatus 100 may put a predetermined restriction on a coding unit at a predetermined location from among the split coding units. The restriction or the predetermined location has been described above in relation to various embodiments, and thus detailed descriptions thereof will not be provided herein.

According to an embodiment, the image decoding apparatus 100 may determine various-shaped coding units by splitting a first coding unit.

Referring to FIG. 9, the image decoding apparatus 100 may split the square first coding unit 900 or a non-square first coding unit 930 or 950 into various-shaped coding units.

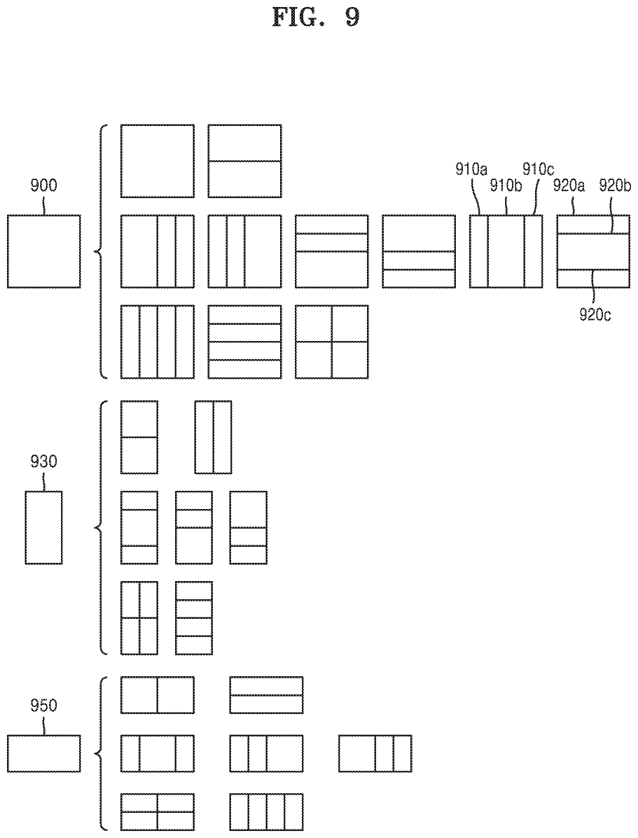

FIG. 10 illustrates that a shape into which a second coding unit is splittable is restricted when the second coding unit having a non-square shape, which is determined as the image decoding apparatus 100 splits a first coding unit 1000, satisfies a predetermined condition, according to an embodiment.

According to an embodiment, the image decoding apparatus 100 may determine to split the square first coding unit 1000 into non-square second coding units 1010a, and 1010b or 1020a and 1020b, based on split shape mode information, which is obtained by the receiver 110. The second coding units 1010a and 1010b or 1020a and 1020b may be independently split. As such, the image decoding apparatus 100 may determine to split or not to split each of the second coding units 1010a and 1010b or 1020a and 1020b into a plurality of coding units, based on the split shape mode information of each of the second coding units 1010a and 1010b or 1020a and 1020b. According to an embodiment, the image decoding apparatus 100 may determine third coding units 1012a and 1012b by splitting the non-square left second coding unit 1010a, which is determined by splitting the first coding unit 1000 in a vertical direction, in a horizontal direction. However, when the left second coding unit 1010a is split in a horizontal direction, the image decoding apparatus 100 may restrict the right second coding unit 1010b to not be split in a horizontal direction in which the left second coding unit 1010a is split. When third coding units 1014a and 1014b are determined by splitting the right second coding unit 1010b in a same direction, because the left and right second coding units 1010a and 1010b are independently split in a horizontal direction, the third coding units 1012a and 1012b or 1014a and 1014b may be determined. However, this case serves equally as a case in which the image decoding apparatus 100 splits the first coding unit 1000 into four square second coding units 1030a, 1030b, 1030c, and 1030d, based on the split shape mode information, and may be inefficient in terms of image decoding.

According to an embodiment, the image decoding apparatus 100 may determine third coding units 1022a and 1022b or 1024a and 1024b by splitting the non-square second coding unit 1020a or 1020b, which is determined by splitting the first coding unit 1000 in a horizontal direction, in a vertical direction. However, when a second coding unit (e.g., the upper second coding unit 1020a) is split in a vertical direction, for the above-described reason, the image decoding apparatus 100 may restrict the other second coding unit (e.g., the lower second coding unit 1020b) to not be split in a vertical direction in which the upper second coding unit 1020a is split.

FIG. 11 illustrates a process, performed by the image decoding apparatus 100, of splitting a square coding unit when split shape mode information is unable to indicate that the square coding unit is split into four square coding units, according to an embodiment.

According to an embodiment, the image decoding apparatus 100 may determine second coding units 1110a and 1110b or 1120a and 1120b, etc. by splitting a first coding unit 1100, based on split shape mode information. The split shape mode information may include information about various methods of splitting a coding unit but, the information about various splitting methods may not include information for splitting a coding unit into four square coding units. According to such split shape mode information, the image decoding apparatus 100 may not split the square first coding unit 1100 into four square second coding units 1130a, 1130b, 1130c, and 1130d. The image decoding apparatus 100 may determine the non-square second coding units 1110a and 1110b or 1120a and 1120b, etc., based on the split shape mode information.

According to an embodiment, the image decoding apparatus 100 may independently split the non-square second coding units 1110a and 1110b or 1120a and 1120b, etc. Each of the second coding units 1110a and 1110b or 1120a and 1120b, etc. may be recursively split in a predetermined order, and this splitting method may correspond to a method of splitting the first coding unit 1100, based on the split shape mode information.

For example, the image decoding apparatus 100 may determine square third coding units 1112a and 1112b by splitting the left second coding unit 1110a in a horizontal direction, and may determine square third coding units 1114a and 1114b by splitting the right second coding unit 1110b in a horizontal direction. Furthermore, the image decoding apparatus 100 may determine square third coding units 1116a, 1116b, 1116c, and 1116d by splitting both of the left and right second coding units 1110a and 1110b in a horizontal direction. In this case, coding units having the same shape as the four square second coding units 1130a, 1130b, 1130c, and 1130d split from the first coding unit 1100 may be determined.

As another example, the image decoding apparatus 100 may determine square third coding units 1122a and 1122b by splitting the upper second coding unit 1120a in a vertical direction, and may determine square third coding units 1124a and 1124b by splitting the lower second coding unit 1120b in a vertical direction. Furthermore, the image decoding apparatus 100 may determine square third coding units 1126a, 1126b, 1126c, and 1126d by splitting both of the upper and lower second coding units 1120a and 1120b in a vertical direction. In this case, coding units having the same shape as the four square second coding units 1130a, 1130b, 1130c, and 1130d split from the first coding unit 1100 may be determined.

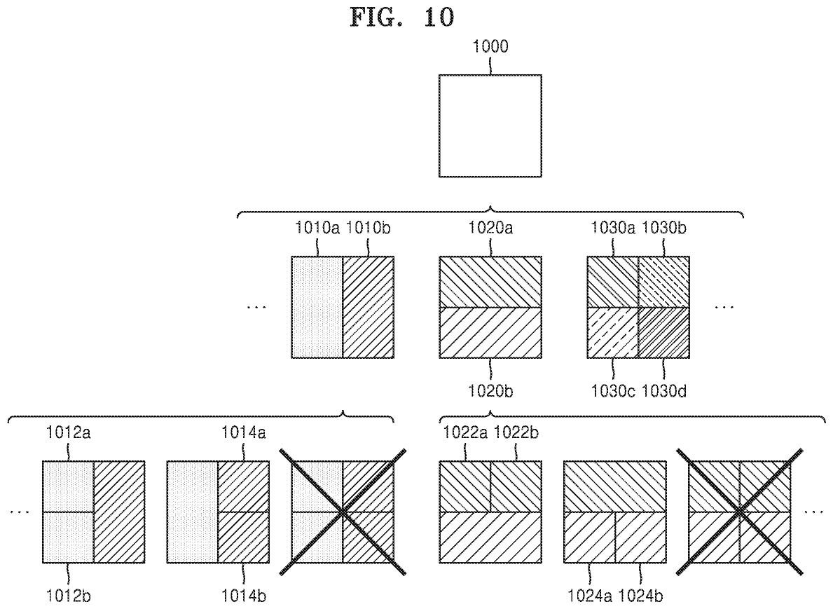

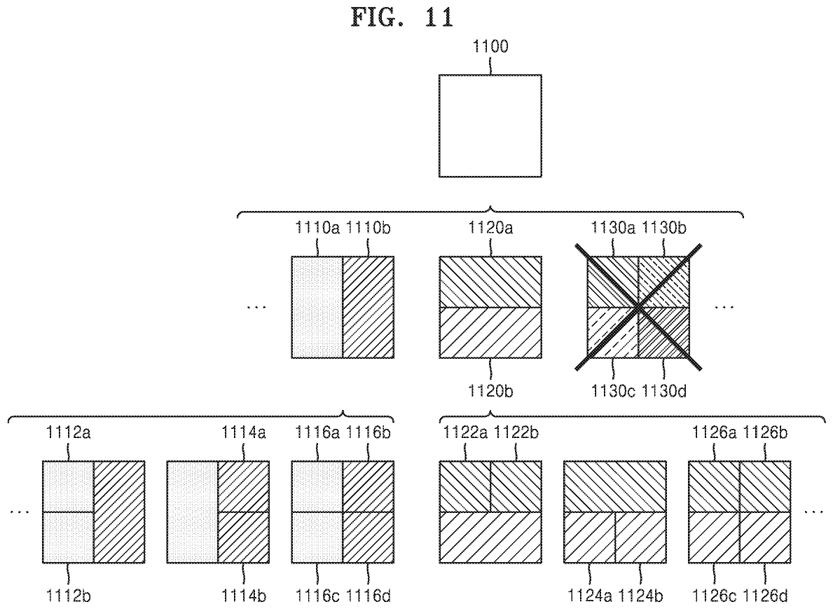

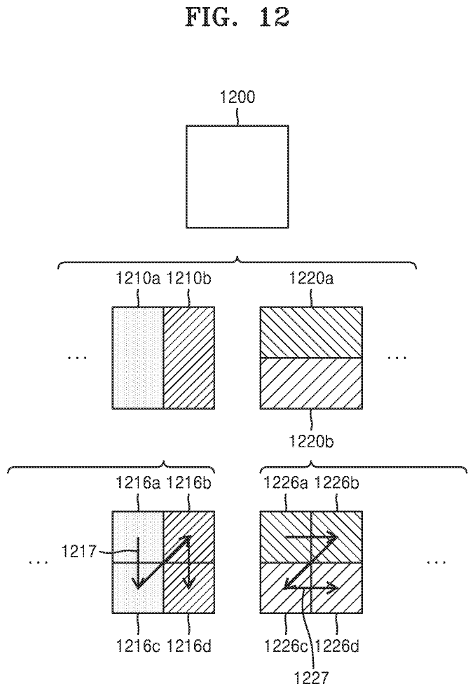

FIG. 12 illustrates that a processing order between a plurality of coding units may be changed depending on a process of splitting a coding unit, according to an embodiment.

According to an embodiment, the image decoding apparatus 100 may split a first coding unit 1200, based on split shape mode information. When a block shape indicates a square shape and the split shape mode information indicates to split the first coding unit 1200 in at least one of horizontal and vertical directions, the image decoding apparatus 100 may determine second coding units 1210a and 1210b or 1220a and 1220b, etc. by splitting the first coding unit 1200. Referring to FIG. 12, the non-square second coding units 1210a and 1210b or 1220a and 1220b determined by splitting the first coding unit 1200 in only a horizontal direction or vertical direction may be independently split based on the split shape mode information of each coding unit. For example, the image decoding apparatus 100 may determine third coding units 1216a, 1216b, 1216c, and 1216d by splitting the second coding units 1210a and 1210b, which are generated by splitting the first coding unit 1200 in a vertical direction, in a horizontal direction, and may determine third coding units 1226a, 1226b, 1226c, and 1226d by splitting the second coding units 1220a and 1220b, which are generated by splitting the first coding unit 1200 in a horizontal direction, in a horizontal (vertical ?) direction. An operation of splitting the second coding units 1210a and 1210b or 1220a and 1220b has been described above in relation to FIG. 11, and thus detailed descriptions thereof will not be provided herein.

According to an embodiment, the image decoding apparatus 100 may process coding units in a predetermined order. An operation of processing coding units in a predetermined order has been described above in relation to FIG. 7, and thus detailed descriptions thereof will not be provided herein. Referring to FIG. 12, the image decoding apparatus 100 may determine four square third coding units 1216a, 1216b, 1216c, and 1216d, and 1226a, 1226b, 1226c, and 1226d by splitting the square first coding unit 1200. According to an embodiment, the image decoding apparatus 100 may determine processing orders of the third coding units 1216a, 1216b, 1216c, and 1216d, and 1226a, 1226b, 1226c, and 1226d based on a splitting method of the first coding unit 1200.

According to an embodiment, the image decoding apparatus 100 may determine the third coding units 1216a, 1216b, 1216c, and 1216d by splitting the second coding units 1210a and 1210b generated by splitting the first coding unit 1200 in a vertical direction, in a horizontal direction, and may process the third coding units 1216a, 1216b, 1216c, and 1216d in a processing order 1217 for initially processing the third coding units 1216a and 1216c, which are included in the left second coding unit 1210a, in a vertical direction and then processing the third coding unit 1216b and 1216d, which are included in the right second coding unit 1210b, in a vertical direction.

According to an embodiment, the image decoding apparatus 100 may determine the third coding units 1226a, 1226b, 1226c, and 1226d by splitting the second coding units 1220a and 1220b generated by splitting the first coding unit 1200 in a horizontal direction, in a vertical direction, and may process the third coding units 1226a, 1226b, 1226c, and 1226d in a processing order 1227 for initially processing the third coding units 1226a and 1226b, which are included in the upper second coding unit 1220a, in a horizontal direction and then processing the third coding unit 1226c and 1226d, which are included in the lower second coding unit 1220b, in a horizontal direction.

Referring to FIG. 12, the square third coding units 1216a, 1216b, 1216c, and 1216d, and 1226a, 1226b, 1226c, and 1226d may be determined by splitting the second coding units 1210a and 1210b, and 1220a and 1920b, respectively. Although the second coding units 1210a and 1210b are determined by splitting the first coding unit 1200 in a vertical direction differently from the second coding units 1220a and 1220b which are determined by splitting the first coding unit 1200 in a horizontal direction, the third coding units 1216a, 1216b, 1216c, and 1216d, and 1226a, 1226b, 1226c, and 1226d split therefrom eventually show same-shaped coding units split from the first coding unit 1200. As such, by recursively splitting a coding unit in different manners based on the split shape information, the image decoding apparatus 100 may process a plurality of coding units in different orders even when the coding units are eventually determined to be the same shape.

FIG. 13 illustrates a process of determining a depth of a coding unit as a shape and size of the coding unit change, when the coding unit is recursively split such that a plurality of coding units are determined, according to an embodiment.

According to an embodiment, the image decoding apparatus 100 may determine the depth of the coding unit, based on a predetermined criterion. For example, the predetermined criterion may be the length of a long side of the coding unit. When the length of a long side of a coding unit before being split is 2n times (n>0) the length of a long side of a split current coding unit, the image decoding apparatus 100 may determine that a depth of the current coding unit is increased from a depth of the coding unit before being split, by n. In the following description, a coding unit having an increased depth is expressed as a coding unit of a deeper depth.

Referring to FIG. 13, according to an embodiment, the image decoding apparatus 100 may determine a second coding unit 1302 and a third coding unit 1304 of deeper depths by splitting a square first coding unit 1300 based on block shape information indicating a square shape (for example, the block shape information may be expressed as ‘0: SQUARE’). Assuming that the size of the square first coding unit 1300 is 2N×2N, the second coding unit 1302 determined by splitting a width and height of the first coding unit 1300 to ½ may have a size of N×N. Furthermore, the third coding unit 1304 determined by splitting a width and height of the second coding unit 1302 to ½ may have a size of N/2×N/2. In this case, a width and height of the third coding unit 1304 are ¼ times those of the first coding unit 1300. When a depth of the first coding unit 1300 is D, a depth of the second coding unit 1302, the width and height of which are ½ times those of the first coding unit 1300, may be D+1, and a depth of the third coding unit 1304, the width and height of which are ¼ times those of the first coding unit 1300, may be D+2.

According to an embodiment, the image decoding apparatus 100 may determine a second coding unit 1312 or 1322 and a third coding unit 1314 or 1324 of deeper depths by splitting a non-square first coding unit 1310 or 1320 based on block shape information indicating a non-square shape (for example, the block shape information may be expressed as ‘1: NS_VER’ indicating a non-square shape, a height of which is longer than a width, or as ‘2: NS_HOR’ indicating a non-square shape, a width of which is longer than a height).

The image decoding apparatus 100 may determine a second coding unit 1302, 1312, or 1322 by splitting at least one of a width and height of the first coding unit 1310 having a size of 2N×N. That is, the image decoding apparatus 100 may determine the second coding unit 1302 having a size of N×N or the second coding unit 1322 having a size of N×N/2 by splitting the first coding unit 1310 in a horizontal direction, or may determine the second coding unit 1312 having a size of N/2×N by splitting the first coding unit 1310 in horizontal and vertical directions.

According to an embodiment, the image decoding apparatus 100 may determine the second coding unit 1302, 1312, or 1322 by splitting at least one of a width and height of the first coding unit 1320 having a size of 2N×N. That is, the image decoding apparatus 100 may determine the second coding unit 1302 having a size of N×N or the second coding unit 1312 having a size of N/2×N by splitting the first coding unit 1320 in a vertical direction, or may determine the second coding unit 1322 having a size of N×N/2 by splitting the first coding unit 1320 in horizontal and vertical directions.

According to an embodiment, the image decoding apparatus 100 may determine a third coding unit 1304, 1314, or 1324 by splitting at least one of a width and height of the second coding unit 1302 having a size of N×N. That is, the image decoding apparatus 100 may determine the third coding unit 1304 having a size of N/2×N/2, the third coding unit 1314 having a size of N/4×N/2, or the third coding unit 1324 having a size of N/2×N/4 by splitting the second coding unit 1302 in vertical and horizontal directions.

According to an embodiment, the image decoding apparatus 100 may determine the third coding unit 1304, 1314, or 1324 by splitting at least one of a width and height of the second coding unit 1312 having a size of N/2×N. That is, the image decoding apparatus 100 may determine the third coding unit 1304 having a size of N/2×N/2 or the third coding unit 1324 having a size of N/2×N/4 by splitting the second coding unit 1312 in a horizontal direction, or may determine the third coding unit 1314 having a size of N/4×N/2 by splitting the second coding unit 1312 in vertical and horizontal directions.

According to an embodiment, the image decoding apparatus 100 may determine the third coding unit 1304, 1314, or 1324 by splitting at least one of a width and height of the second coding unit 1322 having a size of N×N/2. That is, the image decoding apparatus 100 may determine the third coding unit 1304 having a size of N/2×N/2 or the third coding unit 1314 having a size of N/4×N/2 by splitting the second coding unit 1322 in a vertical direction, or may determine the third coding unit 1324 having a size of N/2×N/4 by splitting the second coding unit 1322 in vertical and horizontal directions.

According to an embodiment, the image decoding apparatus 100 may split the square coding unit 1300, 1302, or 1304 in a horizontal or vertical direction. For example, the image decoding apparatus 100 may determine the first coding unit 1310 having a size of 2N×N by splitting the first coding unit 1300 having a size of 2N×2N in a vertical direction, or may determine the first coding unit 1320 having a size of 2N×N by splitting the first coding unit 1300 in a horizontal direction. According to an embodiment, when a depth is determined based on the length of the longest side of a coding unit, a depth of a coding unit determined by splitting the first coding unit 1300 having a size of 2N×2N in a horizontal or vertical direction may be the same as the depth of the first coding unit 1300.

According to an embodiment, a width and height of the third coding unit 1314 or 1324 may be ¼ times those of the first coding unit 1310 or 1320. When a depth of the first coding unit 1310 or 1320 is D, a depth of the second coding unit 1312 or 1322, the width and height of which are ½ times those of the first coding unit 1310 or 1320, may be D+1, and a depth of the third coding unit 1314 or 1324, the width and height of which are ¼ times those of the first coding unit 1310 or 1320, may be D+2.

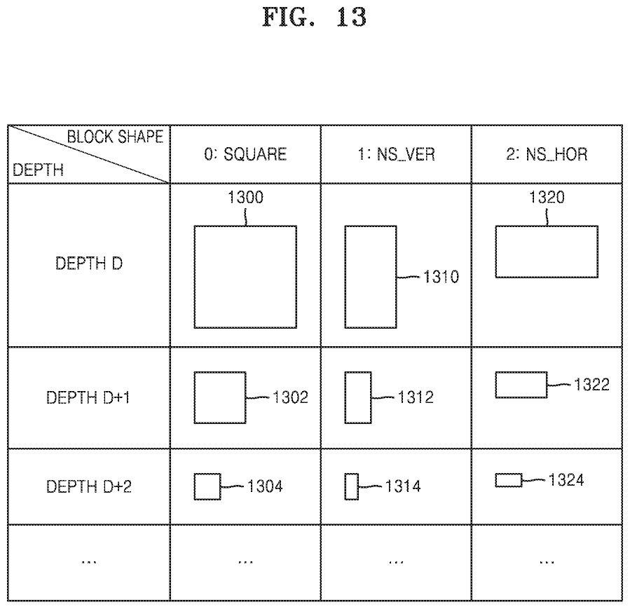

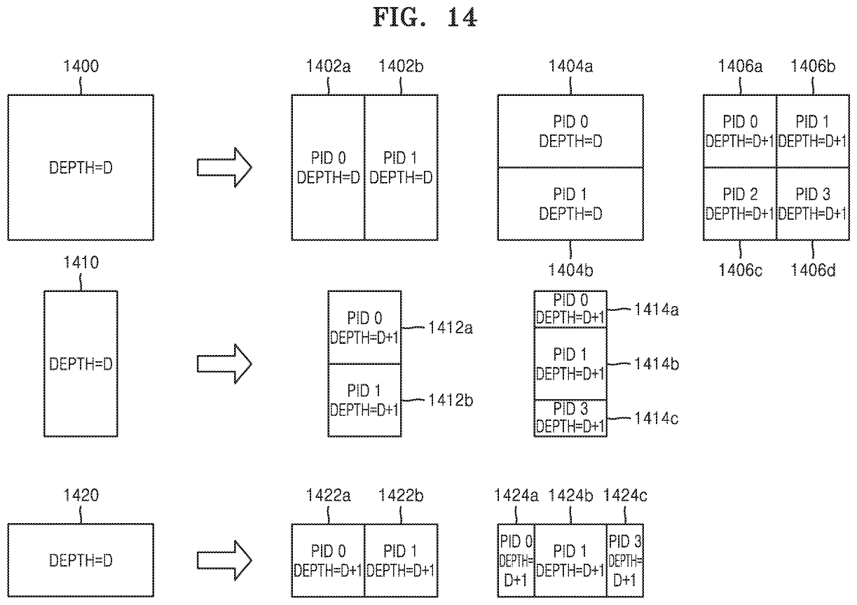

FIG. 14 illustrates depths that are determinable based on shapes and sizes of coding units, and part indexes (PIDs) that are for distinguishing the coding units, according to an embodiment.

According to an embodiment, the image decoding apparatus 100 may determine various-shape second coding units by splitting a square first coding unit 1400. Referring to FIG. 14, the image decoding apparatus 100 may determine second coding units 1402a and 1402b, 1404a and 1404b, and 1406a, 1406b, 1406c, and 1406d by splitting the first coding unit 1400 in at least one of vertical and horizontal directions based on split shape mode information. That is, the image decoding apparatus 100 may determine the second coding units 1402a and 1402b, 1404a and 1404b, and 1406a, 1406b, 1406c, and 1406d, based on the split shape mode information of the first coding unit 1400.

According to an embodiment, a depth of the second coding units 1402a and 1402b, 1404a and 1404b, and 1406a, 1406b, 1406c, and 1406d, which are determined based on the split shape mode information of the square first coding unit 1400, may be determined based on the length of a long side thereof. For example, because the length of a side of the square first coding unit 1400 equals the length of a long side of the non-square second coding units 1402a and 1402b, and 1404a and 1404b, the first coding unit 2100 and the non-square second coding units 1402a and 1402b, and 1404a and 1404b may have the same depth, e.g., D. However, when the image decoding apparatus 100 splits the first coding unit 1400 into the four square second coding units 1406a, 1406b, 1406c, and 1406d based on the split shape mode information, because the length of a side of the square second coding units 1406a, 1406b, 1406c, and 1406d is ½ times the length of a side of the first coding unit 1400, a depth of the second coding units 1406a, 1406b, 1406c, and 1406d may be D+1 which is deeper than the depth D of the first coding unit 1400 by 1.

According to an embodiment, the image decoding apparatus 100 may determine a plurality of second coding units 1412a and 1412b, and 1414a, 1414b, and 1414c by splitting a first coding unit 1410, a height of which is longer than a width, in a horizontal direction based on the split shape mode information. According to an embodiment, the image decoding apparatus 100 may determine a plurality of second coding units 1422a and 1422b, and 1424a, 1424b, and 1424c by splitting a first coding unit 1420, a width of which is longer than a height, in a vertical direction based on the split shape mode information.

According to an embodiment, a depth of the second coding units 1412a and 1412b, and 1414a, 1414b, and 1414c, or 1422a and 1422b, and 1424a, 1424b, and 1424c, which are determined based on the split shape mode information of the non-square first coding unit 1410 or 1420, may be determined based on the length of a long side thereof. For example, because the length of a side of the square second coding units 1412a and 1412b is ½ times the length of a long side of the first coding unit 1410 having a non-square shape, a height of which is longer than a width, a depth of the square second coding units 1412a and 1412b is D+1 which is deeper than the depth D of the non-square first coding unit 1410 by 1.

Furthermore, the image decoding apparatus 100 may split the non-square first coding unit 1410 into an odd number of second coding units 1414a, 1414b, and 1414c based on the split shape mode information. The odd number of second coding units 1414a, 1414b, and 1414c may include the non-square second coding units 1414a and 1414c and the square second coding unit 1414b. In this case, because the length of a long side of the non-square second coding units 1414a and 1414c and the length of a side of the square second coding unit 1414b are ½ times the length of a long side of the first coding unit 1410, a depth of the second coding units 1414a, 1414b, and 1414c may be D+1 which is deeper than the depth D of the non-square first coding unit 1410 by 1. The image decoding apparatus 100 may determine depths of coding units split from the first coding unit 1420 having a non-square shape, a width of which is longer than a height, by using the above-described method of determining depths of coding units split from the first coding unit 1410.

According to an embodiment, the image decoding apparatus 100 may determine PIDs for identifying split coding units, based on a size ratio between the coding units when an odd number of split coding units do not have equal sizes. Referring to FIG. 14, a coding unit 1414b of a center location among an odd number of split coding units 1414a, 1414b, and 1414c may have a width equal to that of the other coding units 1414a and 1414c and a height which is two times that of the other coding units 1414a and 1414c. That is, in this case, the coding unit 1414b at the center location may include two of the other coding unit 1414a or 1414c. Therefore, when a PID of the coding unit 1414b at the center location is 1 based on a scan order, a PID of the coding unit 1414c located next to the coding unit 1414b may be increased by 2 and thus may be 3. That is, discontinuity in PID values may be present. According to an embodiment, the image decoding apparatus 100 may determine whether an odd number of split coding units do not have equal sizes, based on whether discontinuity is present in PIDs for identifying the split coding units.

According to an embodiment, the image decoding apparatus 100 may determine whether to use a specific splitting method, based on PID values for identifying a plurality of coding units determined by splitting a current coding unit. Referring to FIG. 14, the image decoding apparatus 100 may determine an even number of coding units 1412a and 1412b or an odd number of coding units 1414a, 1414b, and 1414c by splitting the first coding unit 1410 having a rectangular shape, a height of which is longer than a width. The image decoding apparatus 100 may use PIDs to identify respective coding units. According to an embodiment, the PID may be obtained from a sample of a predetermined location of each coding unit (e.g., an upper left sample).

According to an embodiment, the image decoding apparatus 100 may determine a coding unit at a predetermined location from among the split coding units, by using the PIDs for distinguishing the coding units. According to an embodiment, when the split shape mode information of the first coding unit 1410 having a rectangular shape, a height of which is longer than a width, indicates to split a coding unit into three coding units, the image decoding apparatus 100 may split the first coding unit 1410 into three coding units 1414a, 1414b, and 1414c. The image decoding apparatus 100 may assign a PID to each of the three coding units 1414a, 1414b, and 1414c. The image decoding apparatus 100 may compare PIDs of an odd number of split coding units to determine a coding unit at a center location from among the coding units. The image decoding apparatus 100 may determine the coding unit 1414b having a PID corresponding to a middle value among the PIDs of the coding units, as the coding unit at the center location from among the coding units determined by splitting the first coding unit 1410. According to an embodiment, the image decoding apparatus 100 may determine PIDs for distinguishing split coding units, based on a size ratio between the coding units when the split coding units do not have equal sizes. Referring to FIG. 14, the coding unit 1414b generated by splitting the first coding unit 1410 may have a width equal to that of the other coding units 1414a and 1414c and a height which is two times that of the other coding units 1414a and 1414c. In this case, when the PID of the coding unit 1414b at the center location is 1, the PID of the coding unit 1414c located next to the coding unit 1414b may be increased by 2 and thus may be 3. When the PID is not uniformly increased as described above, the image decoding apparatus 100 may determine that a coding unit is split into a plurality of coding units including a coding unit having a size different from that of the other coding units. According to an embodiment, when the split shape mode information indicates to split a coding unit into an odd number of coding units, the image decoding apparatus 100 may split a current coding unit in such a manner that a coding unit of a predetermined location among an odd number of coding units (e.g., a coding unit of a centre location) has a size different from that of the other coding units. In this case, the image decoding apparatus 100 may determine the coding unit of the centre location, which has a different size, by using PIDs of the coding units. However, the PIDs and the size or location of the coding unit of the predetermined location are not limited to the above-described examples, and various PIDs and various locations and sizes of coding units may be used.

According to an embodiment, the image decoding apparatus 100 may use a predetermined data unit where a coding unit starts to be recursively split.

FIG. 15 illustrates that a plurality of coding units are determined based on a plurality of predetermined data units included in a picture, according to an embodiment.

According to an embodiment, a predetermined data unit may be defined as a data unit where a coding unit starts to be recursively split by using split shape mode information. That is, the predetermined data unit may correspond to a coding unit of an uppermost depth, which is used to determine a plurality of coding units split from a current picture. In the following descriptions, for convenience of explanation, the predetermined data unit is referred to as a reference data unit.

According to an embodiment, the reference data unit may have a predetermined size and a predetermined size shape. According to an embodiment, a reference coding unit may include M×N samples. Herein, M and N may be equal to each other, and may be integers expressed as powers of 2. That is, the reference data unit may have a square or non-square shape, and may be split into an integer number of coding units.

According to an embodiment, the image decoding apparatus 100 may split the current picture into a plurality of reference data units. According to an embodiment, the image decoding apparatus 100 may split the plurality of reference data units, which are split from the current picture, by using the split shape mode information of each reference data unit. The operation of splitting the reference data unit may correspond to a splitting operation using a quadtree structure.

According to an embodiment, the image decoding apparatus 100 may previously determine the minimum size allowed for the reference data units included in the current picture. Accordingly, the image decoding apparatus 100 may determine various reference data units having sizes equal to or greater than the minimum size, and may determine one or more coding units by using the split shape mode information with reference to the determined reference data unit.

Referring to FIG. 15, the image decoding apparatus 100 may use a square reference coding unit 1500 or a non-square reference coding unit 1502. According to an embodiment, the shape and size of reference coding units may be determined based on various data units capable of including one or more reference coding units (e.g., sequences, pictures, slices, slice segments, largest coding units, or the like).

According to an embodiment, the receiver 110 of the image decoding apparatus 100 may obtain, from a bitstream, at least one of reference coding unit shape information and reference coding unit size information with respect to each of the various data units. An operation of splitting the square reference coding unit 1500 into one or more coding units has been described above in relation to the operation of splitting the current coding unit 300 of FIG. 3, and an operation of splitting the non-square reference coding unit 1502 into one or more coding units has been described above in relation to the operation of splitting the current coding unit 400 or 450 of FIG. 4. Thus, detailed descriptions thereof will not be provided herein.

According to an embodiment, the image decoding apparatus 100 may use a PID for identifying the size and shape of reference coding units, to determine the size and shape of reference coding units according to some data units previously determined based on a predetermined condition. That is, the receiver 110 may obtain, from the bitstream, only the PID for identifying the size and shape of reference coding units with respect to each slice, slice segment, or largest coding unit which is a data unit satisfying a predetermined condition (e.g., a data unit having a size equal to or smaller than a slice) among the various data units (e.g., sequences, pictures, slices, slice segments, largest coding units, or the like). The image decoding apparatus 100 may determine the size and shape of reference data units with respect to each data unit, which satisfies the predetermined condition, by using the PID. When the reference coding unit shape information and the reference coding unit size information are obtained and used from the bitstream according to each data unit having a relatively small size, efficiency of using the bitstream may not be high, and therefore, only the PID may be obtained and used instead of directly obtaining the reference coding unit shape information and the reference coding unit size information. In this case, at least one of the size and shape of reference coding units corresponding to the PID for identifying the size and shape of reference coding units may be previously determined. That is, the image decoding apparatus 100 may determine at least one of the size and shape of reference coding units included in a data unit serving as a unit for obtaining the PID, by selecting the previously determined at least one of the size and shape of reference coding units based on the PID.

According to an embodiment, the image decoding apparatus 100 may use one or more reference coding units included in a largest coding unit. That is, a largest coding unit split from a picture may include one or more reference coding units, and coding units may be determined by recursively splitting each reference coding unit. According to an embodiment, at least one of a width and height of the largest coding unit may be integer times at least one of the width and height of the reference coding units. According to an embodiment, the size of reference coding units may be obtained by splitting the largest coding unit n times based on a quadtree structure. That is, the image decoding apparatus 100 may determine the reference coding units by splitting the largest coding unit n times based on a quadtree structure, and may split the reference coding unit based on at least one of the block shape information and the split shape mode information according to various embodiments.

FIG. 16 illustrates a processing block serving as a criterion for determining a determination order of reference coding units included in a picture 1600, according to an embodiment.

According to an embodiment, the image decoding apparatus 100 may determine one or more processing blocks split from a picture. The processing block is a data unit including one or more reference coding units split from a picture, and the one or more reference coding units included in the processing block may be determined according to a specific order. That is, a determination order of one or more reference coding units determined in each processing block may correspond to one of various types of orders for determining reference coding units, and may vary depending on the processing block. The determination order of reference coding units, which is determined with respect to each processing block, may be one of various orders, e.g., raster scan order, Z-scan, N-scan, up-right diagonal scan, horizontal scan, and vertical scan, but is not limited to the above-mentioned scan orders.

According to an embodiment, the image decoding apparatus 100 may obtain processing block size information and may determine the size of one or more processing blocks included in the picture. The image decoding apparatus 100 may obtain the processing block size information from a bitstream and may determine the size of one or more processing blocks included in the picture. The size of processing blocks may be a predetermined size of data units, which is indicated by the processing block size information.

According to an embodiment, the receiver 110 of the image decoding apparatus 100 may obtain the processing block size information from the bitstream according to each specific data unit. For example, the processing block size information may be obtained from the bitstream in a data unit such as an image, sequence, picture, slice, or slice segment. That is, the receiver 110 may obtain the processing block size information from the bitstream according to each of the various data units, and the image decoding apparatus 100 may determine the size of one or more processing blocks, which are split from the picture, by using the obtained processing block size information. The size of the processing blocks may be integer times that of the reference coding units.

According to an embodiment, the image decoding apparatus 100 may determine the size of processing blocks 1602 and 1612 included in the picture 1600. For example, the image decoding apparatus 100 may determine the size of processing blocks based on the processing block size information obtained from the bitstream. Referring to FIG. 16, according to an embodiment, the image decoding apparatus 100 may determine a width of the processing blocks 1602 and 1612 to be four times the width of the reference coding units, and may determine a height of the processing blocks 1602 and 1612 to be four times the height of the reference coding units. The image decoding apparatus 100 may determine a determination order of one or more reference coding units in one or more processing blocks.

According to an embodiment, the image decoding apparatus 100 may determine the processing blocks 1602 and 1612, which are included in the picture 1600, based on the size of processing blocks, and may determine a determination order of one or more reference coding units in the processing blocks 1602 and 1612. According to an embodiment, determination of reference coding units may include determination of the size of the reference coding units.

According to an embodiment, the image decoding apparatus 100 may obtain, from the bitstream, determination order information of one or more reference coding units included in one or more processing blocks, and may determine a determination order with respect to one or more reference coding units based on the obtained determination order information. The determination order information may be defined as an order or direction for determining the reference coding units in the processing block. That is, the determination order of reference coding units may be independently determined with respect to each processing block.

According to an embodiment, the image decoding apparatus 100 may obtain, from the bitstream, the determination order information of reference coding units according to each specific data unit. For example, the receiver 110 may obtain the determination order information of reference coding units from the bitstream according to each data unit such as an image, sequence, picture, slice, slice segment, or processing block. Because the determination order information of reference coding units indicates an order for determining reference coding units in a processing block, the determination order information may be obtained with respect to each specific data unit including an integer number of processing blocks.

According to an embodiment, the image decoding apparatus 100 may determine one or more reference coding units based on the determined determination order.

According to an embodiment, the receiver 110 may obtain the determination order information of reference coding units from the bitstream as information related to the processing blocks 1602 and 1612, and the image decoding apparatus 100 may determine a determination order of one or more reference coding units included in the processing blocks 1602 and 1612 and determine one or more reference coding units, which are included in the picture 1600, based on the determination order. Referring to FIG. 16, the image decoding apparatus 100 may determine determination orders 1604 and 1614 of one or more reference coding units in the processing blocks 1602 and 1612, respectively. For example, when the determination order information of reference coding units is obtained with respect to each processing block, different types of the determination order information of reference coding units may be obtained for the processing blocks 1602 and 1612. When the determination order 1604 of reference coding units in the processing block 1602 is a raster scan order, reference coding units included in the processing block 1602 may be determined according to a raster scan order. On the contrary, when the determination order 1614 of reference coding units in the other processing block 1612 is a backward raster scan order, reference coding units included in the processing block 1612 may be determined according to the backward raster scan order.

According to an embodiment, the image decoding apparatus 100 may decode the determined one or more reference coding units. The image decoding apparatus 100 may decode an image, based on the reference coding units determined as described above. A method of decoding the reference coding units may include various image decoding methods.

According to an embodiment, the image decoding apparatus 100 may obtain block shape information indicating the shape of a current coding unit or split shape mode information indicating a splitting method of the current coding unit, from the bitstream, and may use the obtained information. The split shape mode information may be included in the bitstream related to various data units. For example, the image decoding apparatus 100 may use the split shape mode information included in a sequence parameter set, a picture parameter set, a video parameter set, a slice header, or a slice segment header. Furthermore, the image decoding apparatus 100 may obtain, from the bitstream, a syntax element corresponding to the block shape information or the split shape mode information according to each largest coding unit, each reference coding unit, or each processing block, and may use the obtained syntax element.

Hereinafter, a method of determining a split rule, according to an embodiment of the disclosure, will be described in detail.

The image decoding device 100 may determine a split rule of an image. The split rule may have been determined in advance between the image decoding device 100 and the image encoding device 2200. The image decoding device 100 may determine a split rule of an image based on information acquired from a bit stream. The image decoding device 100 may determine a split rule based on information acquired from at least one of a sequence parameter set, a picture parameter set, a video parameter set, a slice header, and a slice segment header. The image decoding device 100 may determine a split rule depending on a frame, a slice, a temporal layer, a coding tree unit, or a coding unit.

The image decoding device 100 may determine a split rule based on a block shape of a coding unit. The block shape may include a size, a shape, a ratio of width and height, and a direction of the coding unit. The image encoding device 2200 and the image decoding device 100 may have determined in advance that a split rule is determined based on a block shape of a coding unit, although not limited thereto. However, the image decoding device 100 may determine a split rule based on information acquired from a bit stream received from the image encoding device 2200.

The shape of the coding unit may include a square and a non-square. When the width and height of the coding unit have the same length, the image decoding device 100 may determine the shape of the coding unit as a square. Also, when the width and height of the coding unit have different lengths, the image decoding device 100 may determine the shape of the coding unit as a non-square.

The size of the coding unit may include various sizes of 4×4, 8×4, 4×8, 8×8, 16×4, 16×8, . . . 256×256. The size of the coding unit may be classified according to a length of a longer side of the coding unit, a length of a shorter side of the coding unit, or an area of the coding unit. The image decoding device 100 may apply the same split rule to coding units classified into the same group. For example, the image decoding device 100 may classify coding units having the same longer side length into the same size. Also, the image decoding device 100 may apply the same split rule to the coding units having the same longer side length.

The ratio of width and height of the coding unit may include 1:2, 2:1, 1:4, 4:1, 1:8, 8:1, 1:16, 16:1, 32:1, or 1:32. Also, the direction of the coding unit may include the horizontal direction and the vertical direction. The horizontal direction may represent a case in which a length of the width of the coding unit is longer than a length of the height of the coding unit. The horizontal direction may represent a case in which a length of the width of the coding unit is shorter than a length of the height of the coding unit.

The image decoding device 100 may determine a split rule adaptively based on a size of a coding unit. The image decoding device 100 may determine an allowable split shape mode based on the size of the coding unit. For example, the image decoding device 100 may determine whether a split is allowed, based on a size of a coding unit. The image decoding device 100 may determine a split direction according to a size of a coding unit. The image decoding device 100 may determine an allowable split type according to a size of a coding unit.

Determining a split rule based on a size of a coding unit may be a split rule determined in advance between the image encoding device 2200 and the image decoding device 100. Also, the image decoding device 100 may determine a split rule based on information acquired from a bit stream.

The image decoding device 100 may determine a split rule adaptively based on a position of a coding unit. The image decoding device 100 may determine a split rule adaptively based on a position of a coding unit on an image.

Also, the image decoding device 100 may determine a split rule such that coding units generated through different split paths do not have the same block shape, although not limited thereto. However, coding units generated through different split paths may have the same block shape. Coding units generated through different split paths may have different decoding orders. The decoding orders have been described above with reference to FIG. 12, and therefore, a detailed description thereof will be omitted.

Hereinafter, a method and device for encoding or decoding video by reconstructing a current chroma sample of a current chroma block from a reconstructed current luma sample of a current luma block by using a correlation between a reconstructed adjacent luma sample of an adjacent luma block and a reconstructed adjacent sample of an adjacent chroma block, according to an embodiment of the disclosure, will be described with reference to FIGS. 17 to 20.

FIG. 17 shows a block diagram of a video decoding device 1700 according to an embodiment.

The video decoding device 1700 according to an embodiment may include a memory 1710 and at least one processor 1720 connected to the memory 1710. Operations of the video decoding device 1700 according to an embodiment may operate as individual processors, or by a control of a central processor. Also, the memory 1710 of the video decoding device 1700 may store data received from outside and data generated by the processor 1720, for example, information about weights and deviations for an adjacent luma block and an adjacent chroma block.

To reconstruct chroma samples of a current chroma block, the processor 1720 of the video decoding device 1700 may derive weight information and deviation information about a chroma sample of a reconstructed adjacent chroma block neighboring the current chroma block and a reconstructed luma sample of an adjacent luma block corresponding to the adjacent chroma block, reconstruct luma samples of a current luma block corresponding to the current chroma block to be reconstructed according to a prediction mode of the current luma block, and reconstruct the chroma samples of the current chroma block by using the reconstructed luma samples of the current luma block, the weight information, and the deviation information.

Hereinafter, detailed operations of a video decoding method in which the video decoding device 1700 according to an embodiment reconstructs a current chroma sample of a current chroma block from a reconstructed current luma sample of a current luma block by using a correlation between a reconstructed adjacent luma sample of an adjacent luma block and a reconstructed adjacent sample of an adjacent chroma block will be described with reference to FIG. 18.

FIG. 18 shows a flowchart of a video decoding method according to an embodiment.

Referring to FIG. 18, in operation S1810, to reconstruct chroma samples of a current chroma block, the video decoding device 1700 may derive weight information and deviation information about a chroma sample of a reconstructed adjacent chroma block neighboring the current chroma block and a reconstructed luma sample of an adjacent luma block corresponding to the adjacent chroma block.

According to an embodiment, the weight information and deviation information about the chroma sample of the reconstructed adjacent chroma block and the reconstructed luma sample of the adjacent luma block corresponding to the adjacent chroma block may be expressed by Equation 1.

$$\hat{C} = {\sum }_{k = 1}^{N} {ω}_{k} {L}_{k} + μ \qquad [ Equation 1 ]$$

Ĉ represents the chroma sample, N represents a number of the luma samples, ωₖ represents a weight for each luma sample, Lₖ represents each luma sample, and μ represents a deviation.

As expressed by Equation 1, the chroma sample of the current chroma block may be a value determined by multiplying N predetermined luma samples among the reconstructed luma samples of the current luma block by N predetermined weights respectively corresponding to the N predetermined luma samples in the weight information to determine a weighted sum and adding a deviation value in the deviation information to the weighted sum.

Deviations of the reconstructed luma sample and the reconstructed chroma sample may be modeled by Equations 2 to 4.

$$\begin{matrix}Δ C = \hat{C} - μ = {\sum }_{k = 1}^{N} {ω}_{k} Δ {L}_{k} & [ Equation 2 ] \\ Δ {L}_{k} = {L}_{k} - \overline{L} & [ Equation 3 ] \\ \overline{L} = \frac{1}{M} {\sum }_{m = 1}^{M} {L}_{m} & [ Equation 4 ]\end{matrix}$$

In Equations 2 to 4, a chroma sample difference ΔC which is a difference between the chroma sample value and the deviation represents a weighted sum of values obtained by multiplying a luma sample difference ΔLₖ which is a difference between the luma sample Lₖ and an average value L̅ of the luma samples by a weight ωₖ.

In operation S1830, the video decoding device 1700 may reconstruct the luma samples of the current luma block corresponding to the current chroma block according to the prediction mode of the current luma block.

In operation S1850, the video decoding device 1700 may reconstruct the chroma sample of the current chroma block by using the reconstructed luma samples of the current luma block, the weight information, and the deviation information.

According to an embodiment, a model modeled as expressed by Equations 1 to 4 may be applied to a reconstructed luma component, thereby generating a prediction block of a chroma component.

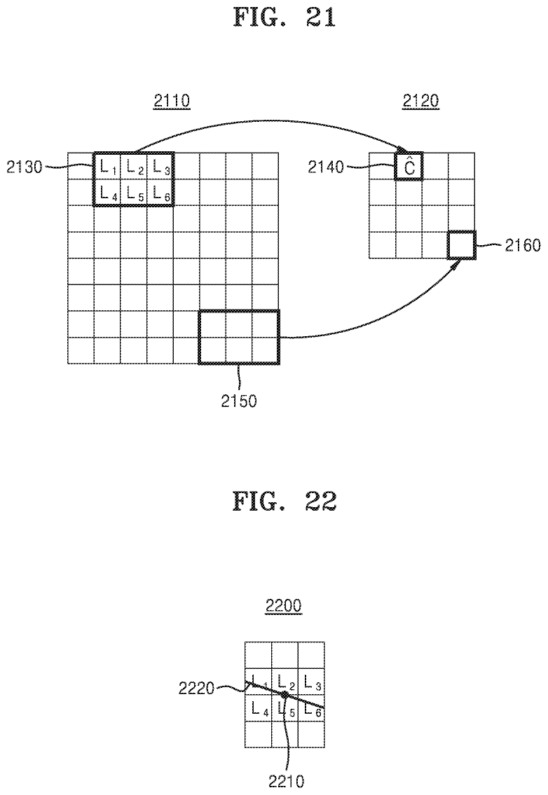

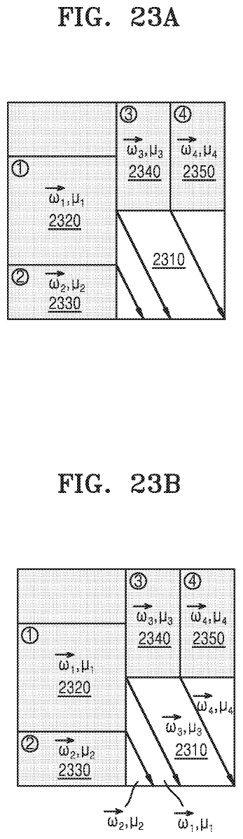

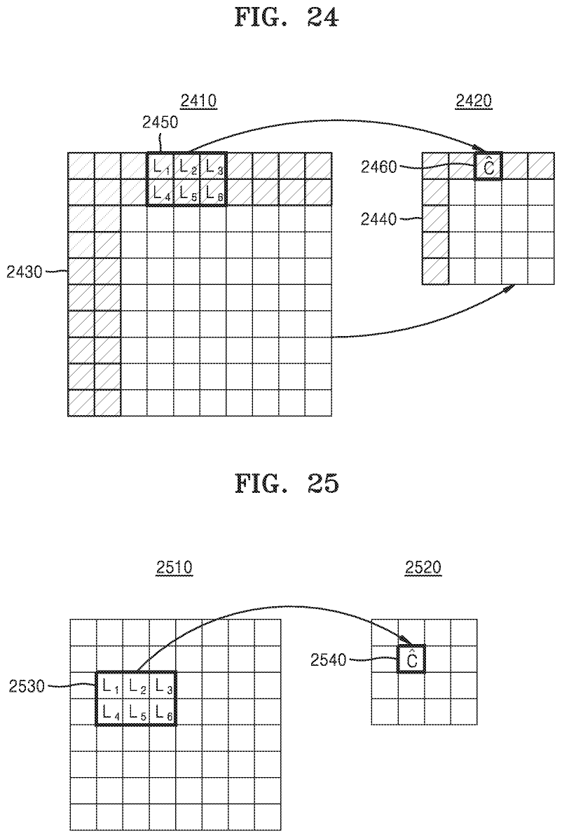

FIG. 24 shows luma samples of a reconstructed luma block and a chroma sample of a reconstructed chroma block.

FIG. 25 shows luma samples of a current luma block and a chroma sample of a current chroma block.

Referring to FIGS. 24 and 25, weight information and deviation information about a correlation between 6 luma samples L₁ to L₆ 2450 among reconstructed adjacent luma samples 2430 neighboring a current luma block 2510 in a luma block 2410 and a chroma sample 2460 of reconstructed adjacent chroma samples 2440 neighboring a current chroma block 2520 in a chroma block 2420 may be derived, and by using the weight information, the deviation information, and the reconstructed luma samples L₁ to L₆ 2530 of the current luma block 2510, derived by a method expressed by Equation 5, a chroma sample C 2540 of the current chroma block 2520 may be reconstructed.

According to an embodiment, N luma pixels may be used to calculate t among the M luma pixels, and when a size of a current block is a W×H size, M=W×H. A local average of some pixels in a block, or an average of all pixels in a block may be used.

According to an embodiment, N predetermined luma samples may be used to predict one or more chroma samples. Also, the N predetermined luma samples may be a luma sample of a current luma block corresponding to a position of a chroma sample of a current chroma block and adjacent samples of the luma sample of the corresponding current luma block, or may be the luma sample of the current luma block corresponding to the position of the chroma sample of the current chroma block and arbitrary samples not neighboring the luma sample of the corresponding current luma block.

FIG. 21 shows an example of generating a predictor Ĉ for the chroma sample by using the 6 luma samples L₁ to L₆.

Referring to FIG. 21, when N is 6, by using 6 luma samples 2130 or 2150 of a luma block 2110, a predictor fora chroma sample 2140 or 2160 of a chroma block 2120, located at a position corresponding to the 6 luma samples 2130 or 2150, may be generated.

More specifically, the predictor Ĉ of the chroma sample may be expressed by Equation 5 or 6.

Ĉ=ω₁ΔL₁+ω₂ΔL₂+ω₃ΔL₃+ω₄ΔL₄+ω₅ΔL₅+ω₆ΔL₆ [Equation 5]

Ĉ=ω₂L₁+ω₂L₂+ω₃L₃+ω₄L₄+ω₅L₅+ω₆L₆+μ [Equation 6]

As seen in Equations 5 and 6, the predictor (of the chroma sample may represent a value obtained by adding a deviation to a weighted sum of sample values (for example, L₁) of luma samples or differences (for example, ΔL₁) that are differences between the luma samples and an average value of the luma samples and weights (for example, ω₁) corresponding to the respective samples values or the respective differences.

According to an embodiment, some of weights ω₁ to ω_{N} may be zero. Also, the above-mentioned 6 luma samples is only an example, and the number of the luma samples is not limited to 6.

According to an embodiment, a prediction mode of an adjacent luma block may be an intra-prediction mode, weight information may be a modeling parameter value representing a correlation between a luma sample of the adjacent luma block and a chroma sample of an adjacent chroma block, and a chroma sample of a current chroma block may be reconstructed by using N predetermined luma samples among reconstructed luma samples of the current luma block, N predetermined weights respectively corresponding to the N predetermined luma samples, and a deviation value of deviation information, wherein the N predetermined weights may be a value obtained by multiplying a fixed weight determined in advance according to the intra-prediction mode by the modeling parameter value representing the correlation between the luma sample and the chroma sample.

More specifically, the chroma sample may be expressed by Equations 7 to 9.

$$\begin{matrix}\hat{C} = {\sum }_{k = 1}^{N} {ω}_{k} {L}_{k} + μ = {\sum }_{k = 1}^{N} s \cdot {ω}_{ip , k}^{′} {L}_{k} + μ , ip \text{:} intra prediction mode & [ Equation 7 ] \\ Δ C = \hat{C} - μ = {\sum }_{k = 1}^{N} {ω}_{k} Δ {L}_{k} = {\sum }_{k = 1}^{N} s \cdot {ω}_{ip , k}^{′} {L}_{k} & [ Equation 8 ] \\ Δ {L}_{k} = {L}_{k} - \frac{1}{M} {\sum }_{m = 1}^{M} {L}_{m} & [ Equation 9 ]\end{matrix}$$

When Ip represents the intra-prediction mode, the modeling parameters ω₁, . . . , ω_{N} may be replaced by s·ω′_{ip,1}, . . . , s·ω′_{ip,N}, respectively, and according to the intra-prediction mode, the modeling parameters s·ω′_{ip,1}, . . . , s·ω′_{ip,N} may be fixed to ω′_{ip,N} so that only modeling parameters s and p may be used.

According to an embodiment, the weights ω′_{ip,N} fixed according to the intra-prediction mode may have the same value in the form of a Gaussian filter, etc. regardless of the intra-prediction mode, or have different values according to the intra-prediction mode.

FIG. 22 shows a reconstructed luma sample, a chroma sample, and an intra-prediction mode direction.

According to an embodiment, referring to FIG. 22, fixed weights may be determined according to an intra-prediction mode direction 2220 of the intra-prediction mode. More specifically, according to the intra-prediction mode direction 2220 of the intra-prediction mode of luma samples L₁, . . . , L₆ of a reconstructed luma block 2200, pixels located in the intra-prediction mode direction 2220 from a position 2210 corresponding to a chroma component may have a higher weight than the other pixels. As shown in FIG. 22, when N=6, fixed weights according to the intra-prediction mode of FIG. 22 may be ω′_{ip,1}=ω′_{ip,6}=¼ and ω′_{ip,2}=W′_{ip,3}=ω′_{ip,4}=ω′_{ip,5}=⅛.

According to an embodiment, ω′_{ip,1}, . . . , ω′_{ip,N} values may be fraction values using a N-tap filter according to the intra-prediction mode.

According to an embodiment, in chroma prediction, when an existing direct mode (DM) is used, a new generalized DM resulting from adding a value calculated through modeling using a luma component to a predictor C_{DM} of a chroma component generated by the existing DM and calculating an average of the addition may be used. More specifically, this may be expressed by Equations 10 and 11, below.

$$\begin{matrix}\hat{C} = ( {C}_{DM} + {\sum }_{k = 1}^{N} {ω}_{k} {L}_{k} + ϵ ) \times \frac{1}{2} & [ Equation 10 ] \\ \hat{C} = ( {C}_{DM} + {\sum }_{k = 1}^{N} {ω}_{k} Δ {L}_{k} + ϵ ) \times \frac{1}{2} & [ Equation 11 ]\end{matrix}$$

The modeling parameters ω₁, . . . , ω_{N} and ε may be calculated by using a luma component and a chroma component of a coded area or an already reconstructed area. The modeling parameters may be calculated by using linear regression, least squares, recursive least squares, wiener filter, etc.

According to another embodiment, when ω′_{ip,1} . . . ω′_{ip,N} being values fixed according to the intra-prediction mode are used instead of ω₁, . . . , ω_{N}, only the modeling parameters s and μ may be calculated by using linear regression, least squares, recursive least squares, wiener filter, etc.

FIGS. 23A and 23B show modeling parameters respectively of a plurality of adjacent blocks neighboring a current block.

Referring to FIGS. 23A and 23B, according to an embodiment, after a luma sample of a luma block and a chroma sample of a chroma block are reconstructed, a modeling parameter may be derived by using the reconstructed samples, and the derived resultant value may be stored and used as a modeling parameter upon chroma intra-prediction of an adjacent block.

According to an embodiment, it is assumed that a coding order of blocks 2320, 2330, 2340, and 2350 of FIG. 23A is an ascending order of \textcircled{1}, \textcircled{2}, \textcircled{3}, and \textcircled{4}. In this case, after the block \textcircled{1} 2320 is coded, a reconstructed image for each of a luma component and a chroma component may be generated, and a relation between the luma component and the chroma component may be modeled so that a modeling parameter may be generated. The modeling parameter ω̅₁̅, μ₁ of the block \textcircled{1} 2320 may be used for intra-prediction of a chroma component of the block \textcircled{2} 2330, and, after coding of the block \textcircled{2} 2330 is completed to generate a reconstructed image, a modeling parameter ω̅₂̅, μ₂ may be generated by using the reconstructed image. Sequentially, the same method may be performed on the block \textcircled{3} 2340 and the block \textcircled{4} 2350. Thereafter, as shown in FIG. 23B, a chroma prediction component value of a current position may be calculated by using a parameter of each area based on an intra-prediction mode direction of a luma component for a current block 2310.

According to an embodiment, modeling parameters modeled for some samples being adjacent to the current block 2310 among all samples of the blocks \textcircled{1} to \textcircled{4} 2320, 2330, 2340, and 2350, instead of modeling parameters for all the samples of the blocks \textcircled{1} to \textcircled{4} 2320, 2330, 2340, and 2350, may be used. For example, modeling parameters derived by modeling samples located at lower positions of the block \textcircled{3} 2340 and the block \textcircled{4} 2350, being adjacent to the current block 2310, modeling parameters derived by modeling samples located at right positions of the block \textcircled{2} 2330, being adjacent to the current block 2310, and modeling parameters derived by modeling samples located at right lower positions of the block \textcircled{1} 2320, being adjacent to the current block 2310, may be used so that chroma samples of the current block 2310 may be predicted.

Also, according to another embodiment, when a chroma component is at a fractional position, a weighted sum of values calculated by using different parameters according to weights of fractions may be used as a pixel value. More specifically, when a left upper sample of the current block 2310 is at a fractional position, a weighted sum of values calculated by using modeling parameters of the block \textcircled{1} 2320 and the block \textcircled{3} 2340 being adjacent to the left upper sample of the current block 2310 may be used as a chroma sample value. The method may be used for signaling or deriving a flag or index, as well as for cross-component intra-prediction of the disclosure.

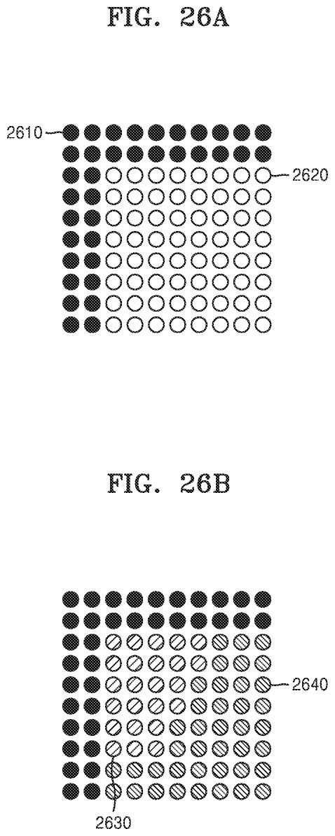

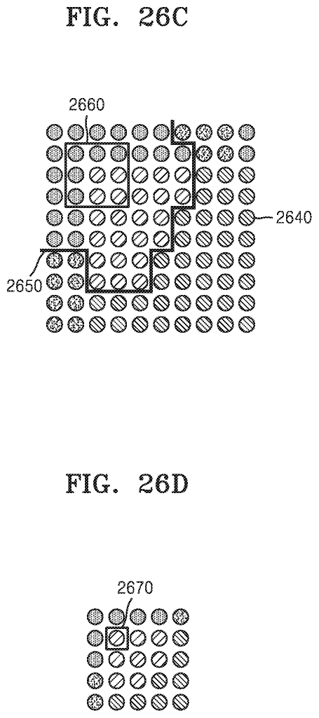

FIGS. 26A, 26B, 26C, and 26D show an example in which a cross-component prediction method is applied when luma samples of a luma block are split according to a predetermined criterion.

FIG. 26A shows reconstructed luma samples 2610 of a luma block and luma samples 2620 of a current luma block, FIG. 26B shows samples 2630 and 2640 split according to a predetermined criterion from the luma samples 2620 of the current luma block, FIG. 26C shows division lines 2650 of luma samples split into a segment area according to a predetermined criterion and lines 2660 representing a band area grouping luma samples that are to be applied to a chroma sample 2670 of FIG. 26D, and FIG. 26D shows the chroma sample 2670 of a chroma block corresponding to the band area of the luma samples.

According to an embodiment, a current luma block may be segmented into at least two first segment areas based on a predetermined criterion, a segment map for the at least two first segment areas may be configured, the current luma block may be down-sampled according to the segment map to segment a current chroma block into at least two second segment areas to correspond to the at least two first segment areas of the current luma block, and chroma samples corresponding to the second segment areas of the current chroma block may be reconstructed by using luma samples of the current luma block belonging to the first segment areas corresponding to the second segment areas of the current chroma block, the weight information, and the deviation information.

More specifically, luma components of the current luma block may be split into L segments, and a segment map for each segment may be configured. By down-sampling the current luma block to apply the segment maps to the current chroma block, a modeling parameter may be derived by using a luma component and a chroma component belonging to the same segment.

According to an embodiment, the segment map may be configured uniformly according to a block size or a predetermined rule. According to another embodiment, the segment map may be configured non-uniformly according to a characteristic, etc. of a reference sample.

According to an embodiment, the segments may be split based on intensities of pixels or by using an average value of the luma components in the current luma block as a threshold value. According to another embodiment, a luma block may be split into band areas determined uniformly, and pixels of a chroma block corresponding to pixels of the luma block belonging to each band area may be determined to be the same segment.

According to the above-described examples, chroma blocks may also be split into a plurality of segment areas to correspond to the luma blocks split into the plurality of segment areas to derive modeling parameters, and a chroma block may be predicted by using the derived modeling parameters, so that an arbitrary shape in a block may be predicted.

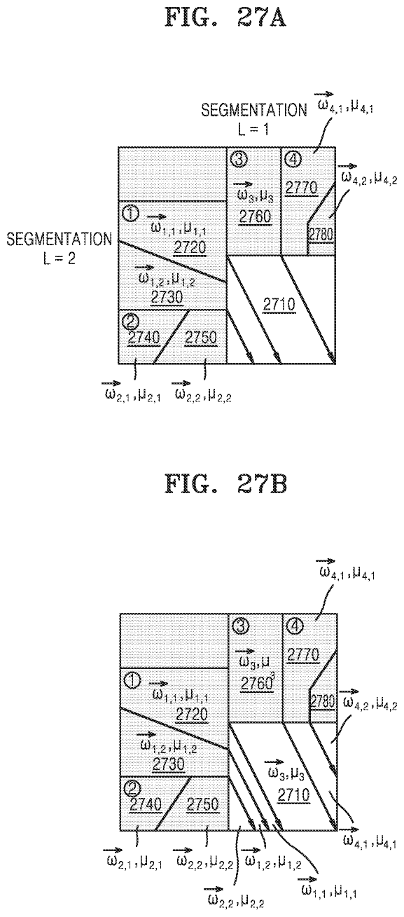

FIGS. 27A and 27B show modeling parameters respectively of a plurality of adjacent blocks including blocks split into segments neighboring a current block.

FIG. 27A shows modeling parameters \vec{ω}_{1,1}, μ_{1,1}, \vec{ω}_{1,2}, μ_{1,2}, \vec{ω}_{2,1}, μ_{2,1}, \vec{ω}_{2,2}, μ_{2,2}, \vec{ω}_{4,1}, μ_{4,1}, and \vec{ω}_{4,2}, μ_{4,2} of a block \textcircled{1} 2720 and 2730, a block \textcircled{2} 2740 and 2750, and a block \textcircled{4} 2770 and 2780, each split into two segment areas, and a modeling parameter \vec{ω}₃, μ₃ of a block \textcircled{3} 2760. FIG. 27B shows a process of using modeling parameters of a plurality of adjacent blocks to reconstruct chroma samples of a current block 2710.

According to an embodiment, referring to FIG. 27B, modeling parameters of areas 2720, 2730, 2750, 2760, 2770 and 2780 of blocks, being adjacent to samples of the current block 2710, among modeling parameters of blocks neighboring the current block 2710 may be used to reconstruct the chroma samples of the current block 2710. In the case of the block \textcircled{2} split into two segments, a modeling parameter of an area 2740 being not adjacent to the current block 2710 may be not used.

According to an embodiment, a reconstructed adjacent luma block and a reconstructed adjacent chroma block that are used to reconstruct a chroma component of a current chroma block may be located in at least one of a left side, an upper side, and a left-upper side of each of a current luma block and the current chroma block.

According to another embodiment, a reconstructed adjacent luma block and a reconstructed adjacent chroma block that are used to reconstruct a chroma component of a current chroma block may be reconstructed earlier than the current luma block and the current chroma block, and may be located in at least one of a right side, an upper side, and a right-upper side of each of the current luma block and the current chroma block.

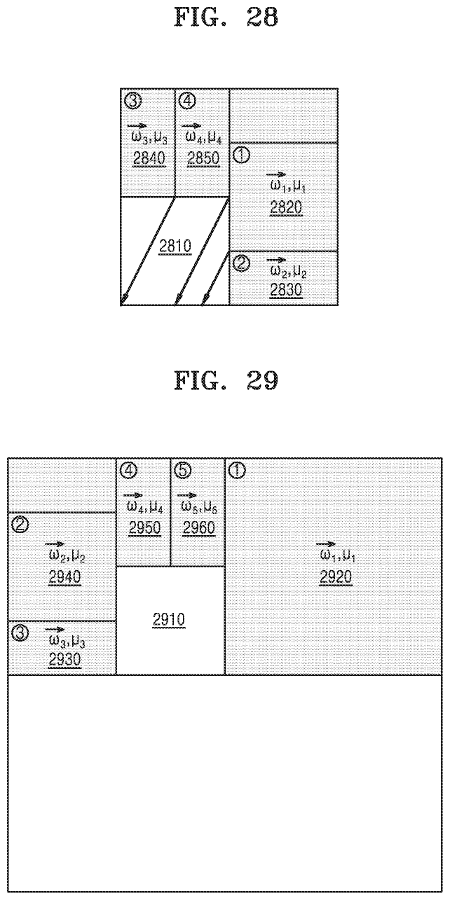

FIG. 28 is a block diagram showing a process of using adjacent blocks located in right, upper, and right-upper sides of a current block.

Referring to FIG. 28, chroma samples of a current block 2810 may be reconstructed by using modeling parameters of a block \textcircled{1} 2820, a block \textcircled{2} 2830, a block \textcircled{3} 2840, and a block \textcircled{4} 2850.

FIG. 29 shows modeling parameters of adjacent blocks located in left, left-upper, upper, right-upper, and right sides of a current block.

Referring to FIG. 29, chroma samples of a current block 2910 may be reconstructed by using modeling parameters \vec{ω}₁, μ₁, \vec{ω}₂, μ₂, \vec{ω}₃, μ₃, \vec{ω}₄, μ₄, and \vec{ω}₅, μ₅ of adjacent blocks 2920, 2930, 2940, 2950, and 2960 located in left, left-upper, upper, right-upper, and right sides of the current block 2910 and reconstructed earlier than the current block 2910. In this case, the method described above with reference to FIGS. 23A, 23B, 27A, and 27B may also be applied.

According to an embodiment, a rate-distortion optimization (RDO) process of selecting an optimal compression tool in consideration of a rate and deterioration may be used to select a block from among the blocks \textcircled{1} to \textcircled{5} to apply a modeling parameter to the current block 2910. For example, the RDO may be used to select up to three blocks from among the adjacent blocks \textcircled{1} to \textcircled{4} of the current block 2910 and apply modeling parameters of the blocks to chroma prediction of the current block 2910. Or, one, two, three, four, or five blocks from among the adjacent blocks \textcircled{1} to \textcircled{5} of the current block 2910 may be selected to apply modeling parameters of the corresponding blocks to chroma prediction of the current block 2910. Or, one, two, or three blocks from among the adjacent blocks \textcircled{1}, \textcircled{4}, and \textcircled{5} of the current block may be selected to apply modeling parameters of the corresponding blocks to chroma prediction of the current block.

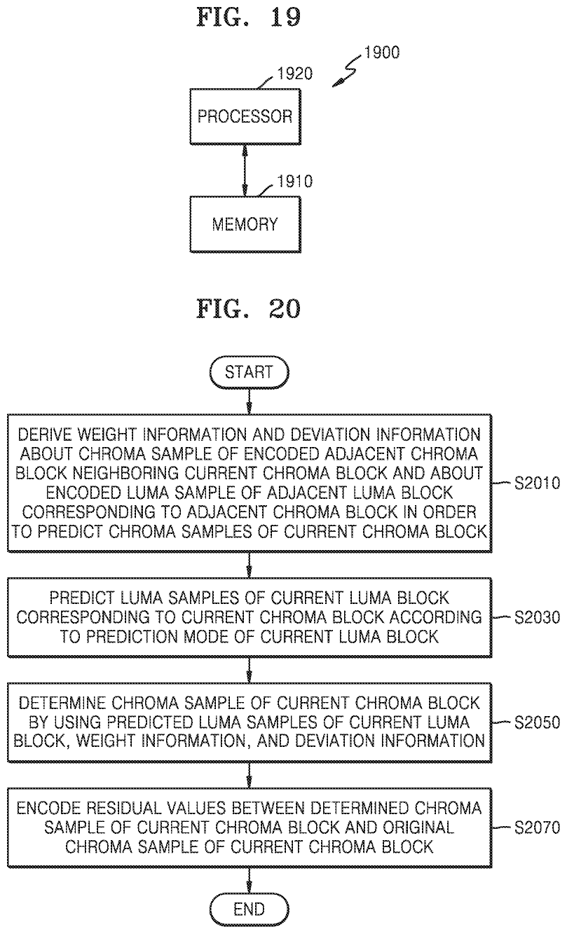

FIG. 19 and FIG. 20 show a block diagram of a video encoding device 1900 according to an embodiment and a flowchart of a video encoding method according to an embodiment, respectively corresponding to the video decoding device and the video decoding method described above.

The video encoding device 1900 according to an embodiment may include a memory 1910 and at least one processor 1920 connected to the memory 1910. Operations of a deriver 1930 according to an embodiment, a luma sample predictor 1940, and the video encoding device 1900 according to an embodiment may operate as individual processors, or by a control of a central processor. Also, the memory 1910 of the video encoding device 1900 may store data received from outside and data (for example, information about weights and deviations of adjacent luma blocks and adjacent chroma blocks) generated by the processor 1920.

To predict chroma samples of a current chroma block, the processor 1920 of the video encoding device 1900 may derive weight information and deviation information about a chroma sample of an adjacent chroma block neighboring the current chroma block and a luma sample of an adjacent luma block corresponding to the adjacent chroma block, predict luma samples of a current luma block corresponding to the current chroma block to be predicted according to a prediction mode of the current luma block, determine the chroma samples of the current chroma block by using the predicted luma samples of the current luma block, the weight information, and the deviation information, and encode residual values between the determined chroma sample of the current chroma block and an original chroma sample of the current chroma block.

Hereinafter, detailed operations of a video decoding method in which a video decoding device 1700 according to an embodiment reconstructs a current chroma sample of a current chroma block from a reconstructed current luma sample of a current luma block by using a correlation between a reconstructed adjacent luma sample of an adjacent luma block and a reconstructed adjacent sample of an adjacent chroma block will be described with reference to FIG. 18.

FIG. 20 shows a flowchart of a video encoding method according to an embodiment.

In operation S2010, to predict chroma samples of a current chroma block, the video encoding device 1900 may derive weight information and deviation information about a chroma sample of an adjacent chroma block neighboring the current chroma block and encoded earlier than the current chroma block and about a luma sample of an adjacent luma block corresponding to the adjacent chroma block, the luma sample of the adjacent luma block encoded earlier than a current luma block corresponding to the current chroma block.

In operation S2030, the video encoding device 1900 may predict luma samples of the current luma block corresponding to the current chroma block according to a prediction mode of the current luma block.

In operation S2050, the video encoding device 1900 may determine a chroma sample of the current chroma block by using the predicted luma samples of the current luma block, the weight information, and the deviation information.

In operation S2070, the video encoding device 1900 may encode residual values between the determined chroma sample of the current chroma block and an original chroma sample of the current chroma block.

According to an embodiment, the cross-component prediction method of the disclosure may replace an existing DM or be used as an independent chroma prediction mode. That is, the cross-component prediction method may be used as another independent mode, as well as the DM, a DC mode, a planar mode, a vertical mode, and a horizontal mode.

According to an embodiment, when video data is coded, the video data may be efficiently coded according to priorities.

According to an embodiment, the chroma prediction mode may be selected through the RDO process or determined in advance according to a block size.

According to an embodiment, a flag for cross-component prediction may be used in unit of a block.

According to an embodiment, a tool similar to the cross-component prediction method may be combined.

According to an embodiment, the cross-component prediction method may be derived and used by using information about surroundings of a prediction block, without signaling.

According to an embodiment, the cross-component prediction method may be applied to inter-prediction to use a correlation between channels, as well as intra-prediction. After residual values between individual components are calculated in inter-prediction, a modeling parameter may be derived from an adjacent block having residual values of a luma component and a chroma component. Thereafter, the derived modeling parameter may be applied to compensate for a residual of a chroma sample of a current block.

So far, various embodiments have been described. It will be apparent that those skilled in the art may readily make various modifications thereto without changing the essential features of the disclosure. Thus, it should be understood that the disclosed embodiments described above are merely for illustrative purposes and not for limitation purposes in all aspects. The scope of the disclosure is defined in the accompanying claims rather than the above detailed description, and it should be noted that all differences falling within the claims and equivalents thereof are included in the scope of the disclosure.

Meanwhile, the embodiments of the disclosure may be written as a program that is executable on a computer, and implemented on a general-purpose digital computer that operates a program using a computer-readable recording medium. The computer-readable recording medium may include a storage medium, such as a magnetic storage medium (for example, ROM, a floppy disk, a hard disk, etc.) and an optical reading medium (for example, CD-ROM, DVD, etc.).

1. A video decoding method comprising:
deriving weight information and deviation information about a chroma sample of a reconstructed adjacent chroma block neighboring a current chroma block and a reconstructed luma sample of an adjacent luma block corresponding to the adjacent chroma block in order to reconstruct chroma samples of the current chroma block;
reconstructing luma samples of a current luma block corresponding to the current chroma block according to a prediction mode of the current luma block; and
reconstructing the chroma samples of the current chroma block by using the reconstructed luma samples of the current luma block, the weight information, and the deviation information.

2. The video decoding method of claim 1, wherein the chroma samples of the current chroma block are respectively values determined by multiplying N predetermined luma samples among the reconstructed luma samples of the current luma block, respectively, by N predetermined weights in the weight information, the N predetermined weights respectively corresponding to the N predetermined luma samples, to obtain weighted sums and adding a deviation value in the weight information to the weighted sums.

3. The video decoding method of claim 2, wherein the N predetermined luma samples are a luma sample of the current luma block corresponding to a position of a chroma sample of the current chroma block and samples neighboring the luma sample of the corresponding current luma block.

4. The video decoding method of claim 2, wherein the N predetermined luma samples are a luma sample of the current luma block corresponding to a position of a chroma sample of the current chroma block and arbitrary samples not neighboring the luma sample of the corresponding current luma block.

5. The video decoding method of claim 1, wherein a prediction mode of the adjacent luma block is an intra-prediction mode,
the weight information is a modeling parameter value representing a correlation between the luma samples and the chroma samples,
the chroma samples of the current chroma block are reconstructed by using N predetermined luma samples among the reconstructed luma samples of the current luma block, N predetermined weights respectively corresponding to the N predetermined luma samples, and a deviation value of the deviation information, and
the N predetermined weights are values resulting from multiplying a fixed weight determined in advance according to the intra-prediction mode by the modeling parameter value representing the correlation between the luma samples and the chroma samples.

6. The video decoding method of claim 5, wherein the fixed weight is determined according to a direction of the intra-prediction mode.

7. The video decoding method of claim 5, wherein the fixed weight is a fraction value using a N-tap filter according to the intra-prediction mode.

8. The video decoding method of claim 1, wherein, when a prediction mode of the current chroma bock is a direct mode (DM), the chroma samples of the current chroma block are respectively averages of a chroma predictor generated in the DM, and
values determined by multiplying N predetermined luma samples in the reconstructed luma samples of the current luma block by N predetermined weights respectively corresponding to the N predetermined luma samples among the weight information to obtain weighted sums and adding a deviation value in the deviation information to the weighted sums.

9. The video decoding method of claim 1, wherein the adjacent chroma block is located in at least one of a left side, an upper side, and a left-upper side of the current chroma block.

10. The video decoding method of claim 1, wherein the adjacent chroma block is reconstructed earlier than the current chroma block, and located in at least one of a right side, an upper side, and a right-upper side of the current chroma block.

11. The video decoding method of claim 1, wherein the adjacent chroma block comprises a plurality of blocks,
the weight information and the deviation information represent correlations between the plurality of blocks and the adjacent luma block corresponding to the plurality of blocks, and
the chroma samples of the current chroma block are reconstructed according to the weight information and the deviation information of the plurality of blocks.

12. The video decoding method of claim 1, further comprising:
segmenting the current luma block into at least two first segment areas based on a predetermined criterion;
configuring a segment map for the at least two first segment areas;
down-sampling the current luma block according to the segment map to segment the current chroma block into at least two second segment areas to correspond to the at least two first segment areas of the current luma block; and
reconstructing a chroma sample corresponding to the second segment areas of the current chroma block by using the weight information, the deviation information, and a luma sample of the current luma block belonging to the first segment areas corresponding to the second segment areas of the current chroma block.

13. A video encoding method comprising:
deriving weight information and deviation information about a chroma sample of an encoded adjacent chroma block neighboring a current chroma block and an encoded luma sample of an adjacent luma block corresponding to the adjacent chroma block in order to reconstruct chroma samples of the current chroma block;
reconstructing luma samples of a current luma block corresponding to the current chroma block according to a prediction mode of the current luma block;
determining the chroma samples of the current chroma block by using the predicted luma samples of the current luma block, the weight information, and the deviation information; and
encoding residual values between the determined chroma samples of the current chroma block and an original chroma sample of the current chroma block.

14. A video decoding device comprising:
a memory; and
at least one processor connected to the memory,
wherein the at least one processor is configured to:
derive weight information and deviation information about a chroma sample of a reconstructed adjacent chroma block neighboring a current chroma block and a reconstructed luma sample of an adjacent luma block corresponding to the adjacent chroma block in order to reconstruct chroma samples of the current chroma block;
reconstruct luma samples of a current luma block corresponding to the current chroma block according to a prediction mode of the current luma block; and
reconstruct the chroma samples of the current chroma block by using the reconstructed luma samples of the current luma block, the weight information, and the deviation information.

15. The video decoding device of claim 14, wherein the chroma samples of the current chroma block are respectively values determined by multiplying N predetermined luma samples among the reconstructed luma samples of the current luma block, respectively, by N predetermined weights in the weight information, the N predetermined weights respectively corresponding to the N predetermined luma samples, to obtain weighted sums, and adding a deviation value in the weight information to the weighted sums.
